(19) United States
(12) Patent Application Publication
(10) Pub. No.: US 2026/0169321 A1
(43) Pub. Date: Jun. 18, 2026

(54) POLARIZATION-MAINTAINING OPTICAL CIRCULATOR

(71) Applicant: SHENZHEN INNOWAVE TECHNOLOGY CO., LTD., SHENZHEN (CN)

(72) Inventor: GUOQIANG CHEN, SHENZHEN (CN)

(21) Appl. No.: 19/537,567

(22) Filed: Feb. 12, 2026

Related U.S. Application Data
(63) Continuation of application No. PCT/CN2024/114025, filed on Aug. 22, 2024.

(30) Foreign Application Priority Data
Sep. 4, 2023 (CN) 202311138879.1

(51) Int. Cl. G02F 1/095; G02B 6/27; G02B 27/28

(52) U.S. Cl. CPC G02F 1/0955; G02B 6/2746; G02B 27/286

(57) ABSTRACT

A polarization-maintaining optical circulator includes: a dual-core waveguide configured to provide port one and port three, a first birefringent crystal, a first Faraday rotator, a second birefringent crystal, a lens and a port two that are successively arranged along the first direction; the first birefringent crystal, the first Faraday rotator, and the second birefringent crystal are all parallel plate structures; the polarization-maintaining optical circulator transmits the light input from port one to port two in the first direction and the light input from port two to port three in the second direction, the first direction and second direction being opposite to each other.

### CROSS-REFERENCE TO RELATED APPLICATIONS

This application is a National Stage of International Patent Application No. PCT/CN2024/114025 with an international filing date of Aug. 22, 2024, which is based upon and claims priority to Chinese Patent Application No. 202311138879.1, filed with the Chinese Patent Office on Sep. 4, 2023, titled “POLARIZATION-MAINTAINING OPTICAL CIRCULATOR”, the entire contents of which are incorporated herein by reference.

### TECHNICAL FIELD

Embodiments of the present disclosure relate to the technical field of optics, and more particularly, relate to a polarization-maintaining optical circulator.

### BACKGROUND

An optical circulator is a multi-port non-reciprocal passive optical device that allows optical signals to be transmitted only along a specified port-sequence and prevents the optical signals from being transmitted in the backward direction. Optical circulators have a wide range of applications in fields such as bidirectional communication on a single fiber in optical communication and optical sensing, as well as in the OADM (Optical Add/Drop Multiplexer) and dispersion compensation.

### SUMMARY

The embodiments of present disclosure provide a polarization-maintaining optical circulator for transmitting the light input from port one to port two in the first direction and the light input from port two to port three in the second direction, where the first direction and the second direction are opposite to each other. The polarization-maintaining optical circulator includes: a dual-core waveguide configured to provide ports one and three, a first birefringent crystal, a first Faraday rotator, a second birefringent crystal, a lens, and port two that are successively arranged along the first direction. The first birefringent crystal, the first Faraday rotator, and the second birefringent crystal are all parallel plate structures. Specifically, port one is a polarization-maintaining port for inputting divergent linearly polarized light, with the light input from port one entering the first birefringent crystal as o-light or e-light. The first birefringent crystal is configured to form a forward first-birefringent-crystal displacement of the light input from port one and then output it to the first Faraday rotator. The first Faraday rotator is configured to rotate the polarization state of the light input from port one by a degrees in the first rotation direction before outputting it to the second birefringent crystal, where a equals 45°. The second birefringent crystal is configured to form a forward second-birefringent-crystal displacement of the light input from port one before outputting it to the lens. The lens is configured to optically shape the light beam input from port one before outputting it to port two. Port two is configured to output the light input from port one, achieving the transmission of light from port one to port two. Port two is also configured to input light and output the input light to the lens. The lens is also configured to optically converge the light beam input from port two before outputting it to the second birefringent crystal. The second birefringent crystal is also configured to form a backward second-birefringent-crystal displacement of the light input from port two before outputting it to the first Faraday rotator. The first Faraday rotator is also configured to rotate the polarization state of the light input from port two by a degrees in the first rotation direction before outputting it to the first birefringent crystal. The first birefringent crystal is also configured to form a backward first-birefringent-crystal displacement of the light input from port two before outputting it to port three. In the first birefringent crystal, the polarization state of the light input from port two is rotated by 90° relative to the polarization state of the light input from port one, resulting in a transformation between o-light and e-light. This ensures that the light input from port two deviates from the light input from port one within the first birefringent crystal, and the relative walk-off within the first birefringent crystal between the light input from port one and the light input from port two is equal to the separation of two cores of the dual-core waveguide, enabling the light input from port two to be coupled into port three. Port three is configured to output the light input from port two, achieving the transmission of light from port two to port three.

### BRIEF DESCRIPTION OF THE DRAWINGS

The accompanying drawings are merely for illustrating some exemplary embodiments, but shall not be construed as limiting the present disclosure. Throughout the drawings, the same reference numerals indicate same part. In the figures:

FIG. 1A is a schematic diagram of the birefringence phenomenon and light displacement of a positive birefringent crystal according to an embodiment of present disclosure;

FIG. 1B is a schematic diagram of the birefringence phenomenon and light displacement of a positive birefringent crystal according to an embodiment of present disclosure;

FIG. 2A is a schematic diagram of the birefringence phenomenon and light displacement of a negative birefringent crystal according to an embodiment of present disclosure

FIG. 2B is a schematic diagram of the birefringence phenomenon and light displacement of a negative birefringent crystal according to an embodiment of present disclosure

FIG. 3 is a schematic diagram of the optical path of a 3-port optical circulator with fully polarization-maintaining input/output waveguide according to Embodiment 1 of the present disclosure;

FIG. 4 is a schematic diagram of the structure and optical axis of birefringent crystal A1 according to an embodiment of the present disclosure;

FIG. 5 is a schematic diagram of the structure and optical axis of birefringent crystal B1 according to an embodiment of the present disclosure;

FIG. 6A is a schematic diagram of the displacement of forward light and backward light in birefringent crystal A1 according to an embodiment of the present disclosure;

FIG. 6B is a schematic diagram of the displacement of forward light and backward light in birefringent crystal B1 according to an embodiment of the present disclosure;

FIG. 7 is a schematic diagram of the optical paths of o-light inputting from port one and e-light inputting from port two in the polarization-maintaining optical circulator according to Embodiment 1 of the present disclosure;

FIG. 8 is a schematic diagram of the displacement of the linearly polarized light inputting in birefringent crystal 22 as o-light in first direction from port one to port two, and in second direction from port two to port three in the polarization-maintaining optical circulator according to Embodiment 1 of the present disclosure;

FIG. 9 is a schematic diagram of the optical path of e-light inputting from port three in the polarization-maintaining optical circulator according to Embodiment 1 of the present disclosure;

FIG. 10 is a schematic diagram of the displacement and isolation function of the linearly polarized light inputting in birefringent crystal 22 as e-light and in direction from port three to port two in the polarization-maintaining optical circulator according to Embodiment 1 of the present disclosure;

FIG. 11 is a schematic diagram of the optical path of a 4-port optical circulator with fully polarization-maintaining input/output waveguide according to Embodiment 2 of the present disclosure;

FIG. 12 is a schematic diagram of the optical path of e-light inputting from port three and o-light inputting from port four in the polarization-maintaining optical circulator according to Embodiment 2 of the present disclosure;

FIG. 13 is a schematic diagram of the displacement of the linearly polarized light inputting in birefringent crystal 22 as e-light in direction from port three to port four, and in direction from port four to port one in the polarization-maintaining optical circulator according to Embodiment 2 of the present disclosure;

FIG. 14 is a schematic diagram of the optical path of a 3-port optical circulator with non-fully polarization-maintaining input/output waveguide and single-stage isolation function according to Embodiment 3 of the present disclosure;

FIG. 15A is a schematic diagram of the structure and optical axis of birefringent crystal C1 according to an embodiment of the present disclosure;

FIG. 15B is a schematic diagram of the displacement of forward light and backward light in birefringent crystal C1 according to an embodiment of the present disclosure;

FIG. 16A is a schematic diagram of the displacement of the linearly polarized light inputting in birefringent crystal 22 as o-light in direction from port one to port two in the polarization-maintaining optical circulator according to Embodiment 3 of the present disclosure;

FIG. 16B is a schematic diagram of the displacement of the linearly polarized light inputting in birefringent crystal 27 as o-light and e-light in direction from port two to port three in the polarization-maintaining optical circulator according to Embodiment 3 of the present disclosure;

FIG. 17A is a schematic diagram of the optical path of o-light inputting from port three in the polarization-maintaining optical circulator according to Embodiment 3 of the present disclosure;

FIG. 17B is a schematic diagram of the optical path of e-light inputting from port three in the polarization-maintaining optical circulator according to Embodiment 3 of the present disclosure;

FIG. 17C is a schematic diagram of the displacement and isolation function of the linearly polarized light inputting in birefringent crystal 22 as o-light and in direction from port three to port two in the polarization-maintaining optical circulator according to Embodiment 3 of the present disclosure;

FIG. 17D is a schematic diagram of the displacement and isolation function of the linearly polarized light inputting in birefringent crystal 22 as e-light and in direction from port three to port two in the polarization-maintaining optical circulator according to Embodiment 3 of the present disclosure;

FIG. 18 is a schematic diagram of the optical path of another 3-port optical circulator with non-fully polarization-maintaining input/output waveguide and single-stage isolation function according to Embodiment 4 of the present disclosure;

FIG. 19A is a schematic diagram of the displacement of the linearly polarized light inputting in birefringent crystal 27 as o-light in direction from port one to port two in the polarization-maintaining optical circulator according to Embodiment 4 of the present disclosure;

FIG. 19B is a schematic diagram of the displacement of the light inputting in birefringent crystal 24 as o-light and e-light in direction from port two to port three in the polarization-maintaining optical circulator according to Embodiment 4 of the present disclosure;

FIG. 20A is a schematic diagram of the optical path of o-light inputting from port three in the polarization-maintaining optical circulator according to Embodiment 4 of the present disclosure;

FIG. 20B is a schematic diagram of the optical path of e-light inputting from port three in the polarization-maintaining optical circulator according to Embodiment 4 of the present disclosure;

FIG. 20C is a schematic diagram of the displacement and isolation function of the linearly polarized light inputting in birefringent crystal 27 as o-light and in direction from port three to port two in the polarization-maintaining optical circulator according to Embodiment 4 of the present disclosure;

FIG. 20D is a schematic diagram of the displacement and isolation function of the linearly polarized light inputting in birefringent crystal 27 as e-light and in direction from port three to port two in the polarization-maintaining optical circulator according to Embodiment 4 of the present disclosure;

FIG. 21A is a schematic diagram of the optical path of another 3-port optical circulator with non-fully polarization-maintaining input/output waveguide and dual-stage isolation function according to Embodiment 5 of the present disclosure;

FIG. 21B is a schematic diagram of the structure and optical axis of birefringent crystal D1 according to an embodiment of the present disclosure;

FIG. 21C is a schematic diagram of the displacement of forward light and backward light in birefringent crystal D1 according to an embodiment of the present disclosure;

FIG. 22A is a schematic diagram of the displacement of the linearly polarized light inputting in birefringent crystal 22 as o-light in direction from port one to port two in the polarization-maintaining optical circulator according to Embodiment 5 of the present disclosure;

FIG. 22B is a schematic diagram of the displacement of the linearly polarized light inputting in birefringent crystal 27 as o-light and e-light in direction from port two to port three in the polarization-maintaining optical circulator according to Embodiment 5 of the present disclosure;

FIG. 23A is a schematic diagram of the optical path of o-light inputting from port three in the polarization-maintaining optical circulator according to Embodiment 5 of the present disclosure;

FIG. 23B is a schematic diagram of the optical path of e-light inputting from port three in the polarization-maintaining optical circulator according to Embodiment 5 of the present disclosure;

FIG. 23C is a schematic diagram of the displacement and isolation function of the linearly polarized light inputting in birefringent crystal 22 as o-light and in direction from port three to port two in the polarization-maintaining optical circulator according to Embodiment 5 of the present disclosure;

FIG. 23D is a schematic diagram of the displacement and isolation function of the linearly polarized light inputting in birefringent crystal 22 as e-light and in direction from port three to port two in the polarization-maintaining optical circulator according to Embodiment 5 of the present disclosure;

FIG. 24 is a schematic diagram of the optical path of 3-port fully polarization-maintaining optical circulator with collimating beam output at port two according to Embodiment 6 of the present disclosure;

FIG. 25A is a schematic diagram of the optical path of a 3-port non-fully polarization-maintaining optical circulator with collimating beam output at port two and single-stage isolation function according to Embodiment 7 of the present disclosure;

FIG. 25B is a schematic diagram of the optical path of another 3-port non-fully polarization-maintaining optical circulator with collimating beam output at port two and single-stage isolation function according to Embodiment 8 of the present disclosure;

FIG. 26 is a schematic diagram of the optical path of a 3-port non-fully polarization-maintaining optical circulator with collimating beam output at port two and dual-stage isolation function according to Embodiment 9 of the present disclosure;

FIG. 27 is a schematic diagram of the optical path of the polarization-maintaining optical circulator with an additional filter based on the embodiment shown in FIG. 24, according to Embodiment 10 of the present disclosure;

FIG. 28A is a schematic diagram of the optical path of the polarization-maintaining optical circulator with an additional filter based on the embodiment shown in FIG. 25a, according to Embodiment 11 of the present disclosure;

FIG. 28B is a schematic diagram of the optical path of the polarization-maintaining optical circulator with an additional filter based on the embodiment shown in FIG. 25b, according to Embodiment 12 of the present disclosure;

FIG. 29 is a schematic diagram of the optical path of the polarization-maintaining optical circulator with an additional filter based on the embodiment shown in FIG. 26, according to Embodiment 13 of the present disclosure;

FIG. 30A is a schematic diagram of the structure and optical axis of the first birefringent crystal as a combined crystal according to an embodiment of the present disclosure; and

FIG. 30B is a schematic diagram of the structure and optical axis of the first birefringent crystal as another combined crystal according to an embodiment of the present disclosure;

### DETAILED DESCRIPTION

Some exemplary embodiments of the present disclosure are hereinafter described in detail with reference to the accompanying drawings. Although the accompanying drawings illustrate the exemplary embodiments of the present disclosure, it shall be understood that the present disclosure may be practiced in various manners, and the present disclosure shall not be limited by the embodiments illustrated herein.

Unless otherwise defined, all technical and scientific terms used in this document have the same meaning as generally understood by those skilled in the technical field to which the present disclosure pertains; the terms used in this document are for the sole purpose of describing specific embodiments and are not intended to limit the present disclosure; the terms “comprising” and “having” and any variations thereof in the present disclosure's description and claims, as well as the drawings, are intended to cover non-exclusive inclusions.

In the description of the embodiments of the present disclosure, the technical terms “first,” “second,” and so on are used only to distinguish different objects and should not be understood to indicate or imply relative importance or to suggest a specific number, specific order, or hierarchy of the technical features indicated. In the description of the embodiments of the present disclosure, the term “multiple” means two or more, unless otherwise specifically limited.

The mention of “embodiment” in this document means that specific features, structures, or characteristics described in conjunction with the embodiment can be included in at least one embodiment of the present disclosure. The phrase appearing at various places in the specification does not necessarily refer to the same embodiment and is not an independent or alternative embodiment that is exclusive of other embodiments. Those skilled in the art understand both explicitly and implicitly that the embodiments described in this document can be combined with other embodiments.

In the description of the embodiments of the present disclosure, the term “and/or” is merely a descriptive association of related objects, indicating that there can be three relationships, for example, A and/or B, which can indicate: the presence of A, the presence of both A and B, or the presence of B alone. Additionally, the character “/” in this document generally indicates an “or” relationship between the associated objects before and after it.

In the description of the embodiments of the present disclosure, the term “multiple” refers to two or more (including two), similarly, “multiple sets” refers to two or more sets (including two sets), and “multiple pieces” refers to two or more pieces (including two pieces).

In the description of the embodiments of the present disclosure, the technical terms “center,” “longitudinal,” “transverse,” “length,” “width,” “thickness,” “top,” “bottom,” “front,” “back,” “left,” “right,” “vertical,” “horizontal,” “top,” “bottom,” “inside,” “outside,” “clockwise,” “counterclockwise,” “axial,” “radial,” and “circumferential” and other directional or positional relationships indicated are based on the orientation or position shown in the drawings, solely for the purpose of facilitating the description of the embodiments of the present disclosure and simplifying the description, and do not indicate or imply that the device or component referred to must have a specific orientation, be constructed and operated in a specific orientation, and therefore should not be understood as a limitation of the embodiments of the present disclosure.

Some current optical circulators in the related art are mainly divided into two designs of structure. One type has ports one, two, and three facing three different directions, with the device's appearance being rectangular, which occupies a larger space and is very inconvenient to arrange. The other type has ports one and three facing the same direction, with port two facing the opposite direction, and the device's appearance is cylindrical. Although this design solution solves the problem of large space occupation in the previous scheme, the overall length is still relatively long. In addition, both of the above schemes are designed for collimating beam, both requiring the use of two or three collimators (e.g., waveguides+lenses), polarization beam splitter, at least one or more Faraday rotators, half-wave plates, Wollaston prism pairs, polarization beam combiners. Too many parts lead to complex and unstable processes.

In the process of implementing the embodiments of this application, the inventor found that the structure of the existing circulators is complex, the cost is high, and the process stability is poor. In view of the above problems, the embodiment of this application provides a minimalist structure of optical circulator designed in convergent beam, which uses birefringent crystals and Faraday rotator to process the convergent beam and makes the port one and port three of the circulator to face the same direction, its structure is simple and greatly reduces spatial size, simplifies manufacturing process and improves product manufacturability.

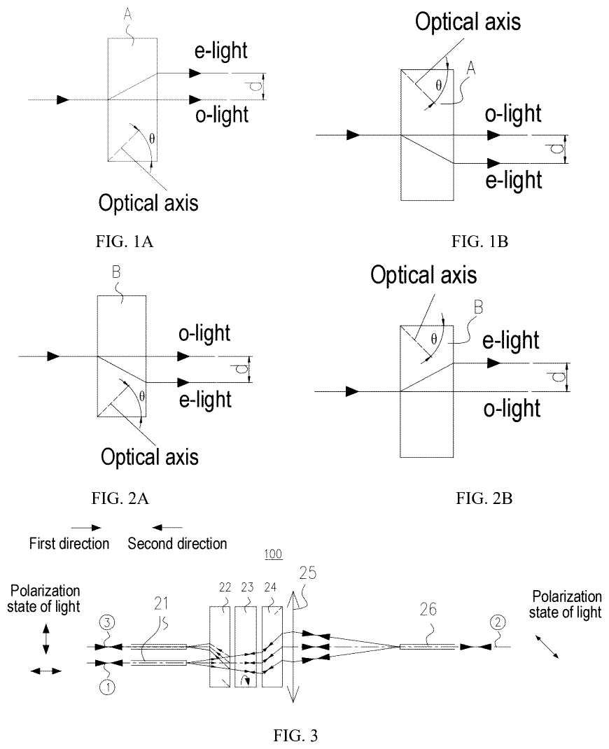

FIGS. 1A and 1B are schematic diagrams of a crystal birefringence phenomenon and a light displacement according to an embodiment of the present disclosure. Using a scenario where a light is normal incident on a positive birefringent crystal A as an example, the light is separated into o light and e light when it enters the positive birefringent crystal A and its polarization state is not well aligned to the o-light and e-light direction. The o light follows the refraction law, and is not subjected to any angle change but enters and exits from the birefringent crystal A along the same direction of the incident light. However, the e light does not follow the refraction law, and is subjected to optical path deviations in the positive birefringent crystal A and exists from the positive birefringent crystal A upon forming a specific displacement d. In this case, a relative walk-off between the o light and the e light is d. The crystal birefringence phenomenon and a light displacement produced by the normal incidence of a light beam into a negative birefringent crystal B is shown in FIGS. 2A and 2B, which will not be described in detail here.

A positive birefringent crystal and a negative birefringent crystal have opposite e light deflection directions. For brevity of description, hereinafter a positive birefringent crystal is used as an example for illustration. An included angle θ between the optical axis of the birefringent crystal A and a normal of an incident surface is a walk-off angle, the walk-off angle is configured to control a relative walk-off between o light and e light in response to the light traveling through the positive birefringent crystal A. In the case that 0°<θ<90°, as illustrated in FIG. 1A, the e light is deflected upwards to form a displacement d; and in the case that −90°<θ<0°, as illustrated in FIG. 1B, the e light is deflected downwards to form a displacement—d. Therefore, by changing the angle θ, the relative walk-off between the o light and the e light at the exit end is changed.

According to one aspect of the embodiment of present disclosure, a polarization-maintaining optical circulator is provided for transmitting light from port one to port two in the first direction, and for transmitting light from port two to port three in the second direction, the first direction and the second direction is opposite. Unless otherwise specified, \textcircled{1} in the drawings of this application embodiment represents the port one, \textcircled{2} represents port two, \textcircled{3} represents port three and \textcircled{4} represents port four. Unless otherwise specified, all ports 1 in the drawings are the port one described in the text of this application, port 2 is the port two described in the text of this application, and port 3 is the port three described in the text of this application. Refer to FIG. 3 for details, FIG. 3 shows the structure of a polarization-maintaining optical circulator as provided in Embodiment 1 of present disclosure. As shown in the figure, the polarization-maintaining optical circulator 100 includes: a first double-core waveguide 21 configured to provide port one and port three, a first birefringent crystal 22, a first Faraday rotator 23, a second birefringent crystal 24, a lens 25, and port two that are successively arranged along the first direction. Port one is a polarization-maintaining port, and the first birefringent crystal 22, the first Faraday rotator 23, and the second birefringent crystal 24 are all parallel plate structures.

Below is an explanation of the transmission process of light between ports in the embodiment of present disclosure.

### 1. From Port One to Port Two:

Port one is configured to input divergent linearly polarized light with a fixed polarization direction. The light input from port one enters the first birefringent crystal 22 as o-light or e-light (FIG. 3 takes o-light as an example). The first birefringent crystal 22 is configured to form a first crystal forward displacement of the light input from port one and then output it to the first Faraday rotator 23. The first Faraday rotator 23 is configured to rotate the polarization state of the light input from port one by an angle of α (45°) in the first rotation direction and then output it to the second birefringent crystal 24. The second birefringent crystal 24 is configured to form a second crystal forward displacement of the light input from port one and then output it to the lens 25. The lens 25 is configured to optically shape (convergent or collimating) the light input from port one and then output it to port two. Port two is configured to output the light input from port one, achieving the transmission of light from port one to port two.

Therein, along the first direction, the polarization state of the o-light of the first birefringent crystal 22 aligns with the polarization state of the o-light or e-light of the second birefringent crystal 24 after passing through the first Faraday rotator 23. In the specific embodiment shown in FIG. 3, along the first direction, the polarization state of the o-light of the first birefringent crystal 22 aligns with the e-light polarization state of the second birefringent crystal 24 after passing through the first Faraday rotator 23. That is, as shown in FIG. 3, the light input from port one enters the first birefringent crystal 22 as o-light and exits in the same direction as the incident light and without optical path deviation. After passing through the first Faraday rotator 23, the polarization state rotates by 45°(which can be clockwise or counterclockwise), and the rotated light's polarization state aligns with the e-light polarization state of the second birefringent crystal 24, and optical path deviation occurs within the second birefringent crystal 24.

In other embodiments, along the first direction, the polarization state of the o-light of the first birefringent crystal 22 can also align with the o-light polarization state of the second birefringent crystal 24 after passing through the first Faraday rotator 23. The o-light of the first birefringent crystal 22 enters and exits the second birefringent crystal 24 in the same direction and without optical path deviation.

### 2. From Port Two to Port Three:

Port two is configured to input divergent linearly polarized light with a fixed polarization direction and output the input light to lens 25. Lens 25 is configured to optically converge the light input from port two and output it to the second birefringent crystal 24. The second birefringent crystal 24 is configured to create a second crystal backward displacement for the light input from port two and output it to the first Faraday rotator 23. In other embodiments, the light input from port two may also be randomly polarized light, and detailed explanations will be provided in specific embodiments below.

The first Faraday rotator 23 is configured to rotate the polarization state of the light input from port two by an angle α (45°) in the first rotation direction and output it to the first birefringent crystal 22. The rotation of the polarization state of the light beam by the Faraday rotator has been mentioned earlier. Accordingly, if viewed from left to right in FIG. 3, both the polarization-state rotation direction of the light from port one to port two and the light from port two to port three are in a clockwise direction or in a counterclockwise direction after passing through the first Faraday rotator 23. Therefore, the polarization state of the light input from port two undergoes a 90° rotation in the first birefringent crystal 22 relative to the light input from port one after passing through the first Faraday rotator 23, and the o-light and e-light undergo transformation.

Based on this, the light path of the light input from port one and the light input from port two is completely coincident between the port two and the first Faraday rotator 23 along the second direction, except for the transformation of the o-light and e-light and their relative displacement in the first birefringent crystal 22.

The light continues to enter the first birefringent crystal 22 which is configured to create a first crystal backward displacement for the light input from port two, and then output to port three, as shown above. The polarization state of the light input from port two is rotated by 90° relative to the polarization state of the light input from port one in the first birefringent crystal 22, causing the light input from port two to deviate from the light input from port one due to the transformation of the o-light and e-light in the first birefringent crystal 22. The walk-off between the light input from port one and the light input from port two is equal to the separation of two cores of the dual-core waveguide 21, allowing the light input from port two to couple into port three. port three is configured to output the light input from port two, achieving the transmission of light from port two to port three. In this case, the walk-off is equal to the sum of the first crystal forward displacement, the second crystal forward displacement, the second crystal backward displacement, and the first crystal backward displacement.

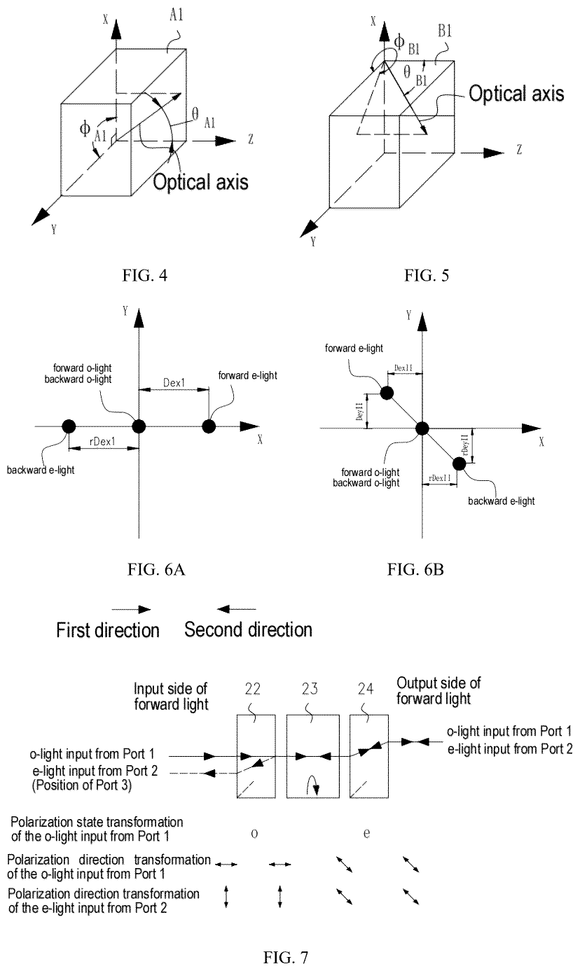

For easy understanding of the specific embodiment, the following explanation takes the example that the light input from port one is normal incident into the first birefringent crystal 22. The same functionality provided in the embodiments of present disclosure also applies to the case of oblique incidence of the light input from port one. First, two types of birefringent crystals are provided as examples for illustration. In the specific embodiment, different alignment methods of the o-light and e-light of these two birefringent crystals can form different schemes. Please refer to FIGS. 4 and 5 for details. FIG. 4 schematically shows the structure and optical axis of birefringent crystal A1, and FIG. 5 shows the structure and optical axis of birefringent crystal B1.

As shown in FIG. 4, birefringent crystal A1 is a parallel plate structure, a three-dimensional Cartesian coordinate system is established with the incidence surface of the light input from port one as the xy plane where the x axis and y axis are located, and the first direction as the positive direction of z-axis, where the normal to the incidence surface of birefringent crystal A1 of the light input from port one is parallel to the z-axis. The angle θA1 between the optical axis of birefringent crystal A1 and the normal to the incidence surface of the light input from port one (i.e., the z-axis) is its walk-off angle. The angle φA1 between the y-axis and the line where the e-light oscillation plane through the optical axis of birefringent crystal A1 intersects the xy plane is φA1=90° in FIG. 4. FIG. 6A shows a diagram of the light displacement in birefringent crystal A1 (The first direction is defined as forward direction and the second direction is defined as backward direction in FIGS. 6A-6B and subsequent). An x, y-axis Cartesian coordinate system on the incidence surface of birefringent crystal A1 is established with the incidence point of the light input from port one as the origin. Both the relative displacement of the light input from port one and the light input from port two are referred to the xyz coordinate system of the light input from port one. As shown in FIG. 6A, when the light input from port one is normally incident on birefringent crystal A1, the forward o-light follows the law of refraction and does not undergo displacement within the xy plane and exit the birefringent crystal A1 at the origin, that is, the forward o-light displacement in the x-axis direction of birefringent crystal A1 is DoxI=0, and the displacement in the y-axis direction is DoyI=0; the forward e-light does not follow the law of refraction and exit the birefringent crystal A1 with the x-axis direction displacement set to DexI=2a and the y-axis direction displacement set to DeyI=0. Correspondingly, the backward o-light with normal incidence also does not undergo displacement, and the backward e-light displacement in the x-axis and γ-axis direction of birefringent crystal A1 is rDexI=−2a and rDeyI=0 respectively. Of course, other displacement values can be adopted according to specific situations, and this is not limited here.

As shown in FIG. 5, the birefringent crystal B1 is also a parallel plate structure, and a three-dimensional Cartesian coordinate system is established in the birefringent crystal B1 in the same manner as in birefringent crystal A1. The angle θB1 between the optical axis of birefringent crystal B1 and the normal to the incidence surface of the light input from port one (i.e., the z-axis) is its walk-off angle. The angle φB1 between the y-axis and the line where the e-light oscillation plane through the optical axis of birefringent crystal B1 intersects the xy plane is φB1=315° in FIG. 5. FIG. 6B shows a schematic diagram of the light displacement in birefringent crystal B1. The coordinate system is established and referenced in the same way as for the aforementioned birefringent crystal A1. As shown in FIG. 6B, the displacement of the forward e-light normal incident on birefringent crystal B1 is DexII=−a and DeyII=a. Correspondingly, the displacement of the backward e-light normal incident on birefringent crystal B1 is rDexII=a, rDeyII=−a. Of course, other displacement values can be adopted according to specific situations, and this is not limited here.

In this embodiment, the first birefringent crystal 22 adopts the aforementioned birefringent crystal A1, and the second birefringent crystal 24 adopts the aforementioned birefringent crystal B1. The angle θ1 between the normal to the incidence surface of the light input from Port one and the optical axis of the first birefringent crystal 22 is the first walk-off angle, with −90°<θ1<0° or 0°<θ1<90°. The first walk-off angle is configured to control the first crystal forward displacement and the first crystal backward displacement.

The angle θ2 between the normal to the incidence surface of the light input from Port one and the optical axis of the second birefringent crystal 24 is the second walk-off angle, with −90°<θ2<0° or 0°<θ2<90°. The second walk-off angle is configured to control the second crystal forward displacement and the second crystal backward displacement.

In the embodiment, an xyz coordinate system is established with the first direction of the optical path as the positive direction of z-axis. The e-light oscillation plane through the optical axis of the first birefringent crystal 22 intersects the xy plane at the first line, and the angle between the first line and the y-axis is φ1. The e-light oscillation plane through the optical axis of the second birefringent crystal 24 intersects the xy plane at the second line, and the angle between the second line and the y-axis is φ2. The relationship is set as |φ2−φ1|=(90°±α) or |φ2−φ1|=(270°±α).

φ1 can refer to the description of φA1 of birefringent crystal A1 in FIG. 4; φ2 can refer to the description of φB1 of birefringent crystal B1 in FIG. 5. By setting the relationship between φ1 and φ2 as |φ2−φ1|=(90°±α) or |φ2−φ1|=(270°±α), it ensures that the polarization state of the light exiting the first birefringent crystal 22 can align with the o-light or e-light of the second birefringent crystal 24 after passing through the first Faraday rotator 23. The specific values are φ1=90° and φ2=315°, satisfying the condition |φ2−φ1|=(90°±α) or |φ2−φ1|=(270°±α).

### Regarding the Polarization-Maintaining of the Ports:

In the embodiment shown in FIG. 3, all ports are polarization-maintaining ports, which means a fully polarization-maintaining solution is provided, where ports one, two, and three are all polarization-maintaining ports. The polarization state of port two is aligned with the polarization state of the light input from port one and passed through the lens 25 along the first direction. The polarization state of port three is aligned with the polarization state of the light input from port two and passed through the first birefringent crystal 22 along the second direction. Embodiment 1, 2, 6, and 10 will be taken for explanation in the following text.

In some other embodiments, port one is a polarization-maintaining port, and the polarization-maintaining condition of ports two and three is not specified. For instance, port two can be either a polarization-maintaining port or a non-polarization-maintaining port, and port three can also be either a polarization-maintaining port or a non-polarization-maintaining port, and the circulator can be either fully polarization-maintaining or non-fully polarization-maintaining. Embodiments 3, 4, 5, 7, 8, 9, 11, 12, and 13 will be taken for explanation in the following text.

### Regarding the Characteristics of Input and Output Light at Port Two:

In the embodiment shown in FIG. 3, port two is a single-core waveguide 26 and is configured for outputting convergent beam or inputting divergent beam. Lens 25 is configured to focus the light input from port one into convergent beam and couple it into single-core waveguide 26 which then outputs the convergent beam; single-core waveguide 26 is also configured to input divergent linearly polarized light and output this divergent beam to lens 25, lens 25 is configured to focus the light input from single-core waveguide 26 into convergent beam. Embodiments 1 to 5 will be taken for explanation in the following text.

In some embodiments, port two is configured to output or input collimating beam. Lens 25 is configured to collimate the light input from port one into collimating beam and output it to port two, which then outputs this collimating beam; port two is also configured to input collimating beam and output this collimating beam to lens 25, lens 25 is configured to focus the light input from port two into convergent beam. Embodiments 6 to 13 will be taken for explanation in the following text.

Detailed explanations will be provided in specific embodiments below.

### Embodiment 1

Please refer to FIG. 3, which is a schematic diagram of the optical path of a 3-port optical circulator with fully polarization-maintaining input/output waveguide according to Embodiment 1 of the present disclosure;

In this embodiment, the first birefringent crystal 22 adopts the aforementioned birefringent crystal A1, and the second birefringent crystal 24 adopts the aforementioned birefringent crystal B1. The polarization state of the light input from port one is o-light in the first birefringent crystal 22 and e-light in second birefringent crystal 24 along the first direction.

Please refer to FIG. 7 for the schematic diagram of the optical paths of o-light inputting from port one and e-light inputting from port two in the polarization-maintaining optical circulator according to Embodiment 1. An xyz coordinate system is established with the first direction as the positive direction of z-axis as shown in the FIG. 7. The o-light input from port one will not deviate in the first birefringent crystal 22 and exit from the output surface of the first birefringent crystal 22 at the same xy coordinates as the incident surface; then the polarization state of the light rotates by 45° and aligns with the e-light polarization state of the second birefringent crystal 24 after passing through the first Faraday rotator 23; the o-light input from port one deviates in optical path when exiting from the second birefringent crystal 24. For the e-light input from port two, the optical path of the e-light input from port two coincides with that of the o-light input from port one between the input surface of the second birefringent crystal 24 and the output surface of the first Faraday rotator 23 along the second direction; however, the polarization state of the e-light input from port two rotates by 45° in the same direction as the o-light input from port one after passing through the first Faraday rotator 23. Since the o-light input from port one rotated its polarization state by 45° in the same direction when passing through the first Faraday rotator 23 in the first direction, the e-light input from port two has accumulated a polarization rotation of 90° relative to the o-light input from port one. Specifically, the polarization direction changes of the o-light input from port one and the e-light input from port two is shown in FIG. 7. The polarization state of the e-light input from port two is perpendicular to that of the o-light input from port one in the first birefringent crystal 22, that means the transformation between the o-light and e-light. The polarization state of the e-light input from port two aligns with the e-light polarization state of the first birefringent crystal 22; then, the e-light input from port two deviates from the o-light input from port one after passing through the first birefringent crystal 22.

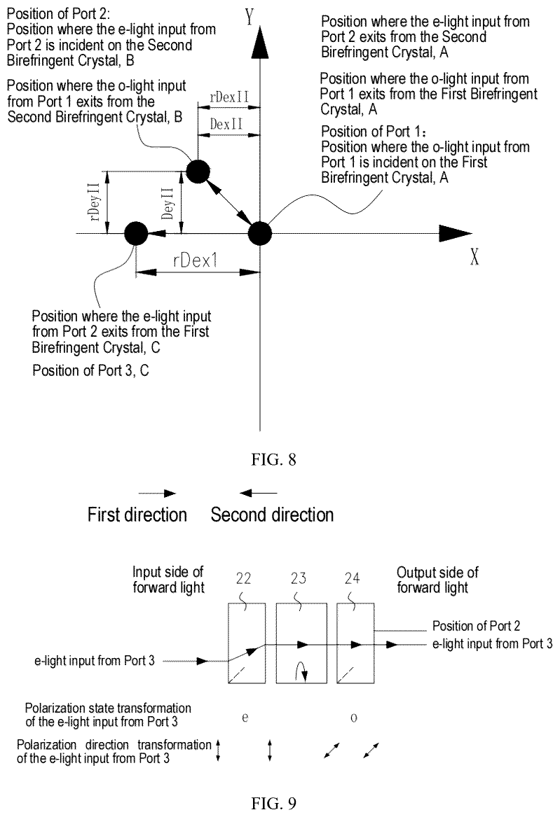

This embodiment also provides a schematic diagram of the projection positions of the beam's entry and exit points on the xy plane in each birefringent crystal. Refer to FIG. 8 for details. The o-light input from port one is incident on the first birefringent crystal 22 at point A (the origin of coordinate system) and then still exit at point A (0,0) without deviation in the first birefringent crystal 22. The polarization state of the o-light input from port one rotates by 45° and aligns with the e-light polarization state of the second birefringent crystal 24 after passing through the first Faraday rotator 23, and then generates the displacements of DexII=−a and DeyII=a along the x-axis and γ-axis respectively, and exit at point B (−a, a). The e-light input from port two is incident on the second birefringent crystal 24 at point B, generates the displacements of rDexII=a and rDeyII=−a along the x-axis and γ-axis respectively, and exits at point A (0, 0). The polarization state of the e-light input from port two aligns with the e-light polarization state of the first birefringent crystal 22 after passing through the first Faraday rotator 23, and then generates the displacements of rDexI=−2a and rDeyI=0 along the x-axis and γ-axis respectively, and exits at point C (−2a, 0) and couples into port three. Based on this, the coordinates of the entry point on the first birefringent crystal 22 of the o-light input from port one is A (0,0), the coordinates of the exit point on the first birefringent crystal 22 of the e-light input from port two is C (−2a,0), the position of two cores of the first dual-core waveguide 21 are aligned with points A and C and the polarization states of the two cores are aligned with the o-light and e-light polarization states of the first birefringent crystal 22 respectively.

Please refer to FIG. 9 for the schematic diagram of the optical paths of e-light inputting from port three in the polarization-maintaining optical circulator according to Embodiment 1. The e-light input from port three will deviate in the first birefringent crystal 22 and exit from the output surface of the first birefringent crystal 22; then the polarization state of the light rotates by 45° and aligns with the o-light polarization state of the second birefringent crystal 24 after passing through the first Faraday rotator 23; the e-light input from port three will not deviate in optical path when exiting from the second birefringent crystal 24, and exit from the output surface of the second birefringent crystal 24 at the same xy coordinates as the incident surface. The polarization state of the e-light input from port two is rotated by 90° relative to the polarization state of the e-light input from port three in the second birefringent crystal 24, causing the e-light input from port three to deviate from the e-light input from port two and can't couple into port two due to the transformation of the o-light and e-light in the second birefringent crystal 24.

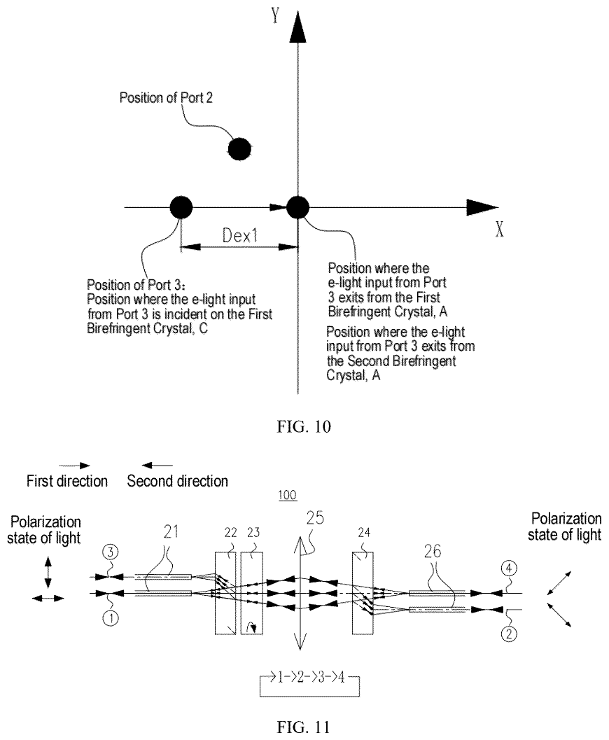

This embodiment also provides a schematic diagram of the projection positions of the beam's entry and exit points on the xy plane in each birefringent crystal as the optical path shown in FIG. 9. Refer to FIG. 10 for details. As previously described, the e-light input from port two exits the first birefringent crystal 22 at point C and then couples into port three, so the e-light input from port three is still incident on the first birefringent crystal 22 at point C as e-light polarization state, and then generates the displacements of DexI=2a and DeyI=0 along the x-axis and γ-axis respectively, and exit at point A. The polarization state of the e-light input from port three rotates by 45° and aligns with the o-light polarization state of the second birefringent crystal 24 after passing through the first Faraday rotator 23, three is no deviation in the second birefringent crystal 24 and still exit at point A. Based on this, the exit point A on the second birefringent crystal 24 of the e-light input from port three deviates from the incident point B of the e-light input from port two, and the e-light input from port three can't couple into port two and achieve the backward isolation function from port three to port two. As for the aforementioned that the e-light input from port two couples into port three, the backward isolation function from port two to port one is achieved too.

In other embodiments, the arrangement of the optical path are the same as in the aforementioned Embodiment 1, the only difference is that the φ angle of the birefringent crystals and/or the rotation direction of the Faraday is changed and make the polarization state of the o-light input from port one as o-o in the first birefringent crystal 22 and in the second birefringent crystal 24, or the polarization state of the e-light input from port one as e-o in the first birefringent crystal 22 and in the second birefringent crystal 24, or the polarization state of the e-light input from port one as e-e in the first birefringent crystal 22 and in the second birefringent crystal 24. By reasonably setting the φ angle and the relative displacement between o-light and e-light of the first birefringent crystal 22 and the second birefringent crystal 24, and the polarization-state relationship of o-light and e-light between the birefringent crystals, and then matching the dual-core spacing and polarization direction of the dual-core polarization-maintaining waveguide, the optical circulating and backward isolation functions can also be achieved too. The specific changes in polarization state and beam displacement are similar and will not be further elaborated here.

### Embodiment 2

FIG. 11 is a schematic diagram of the optical path of a 4-port optical circulator with fully polarization-maintaining input/output waveguide according to Embodiment 2 of the present disclosure;

In this embodiment, the first birefringent crystal 22 adopts the aforementioned birefringent crystal A1, and the second birefringent crystal 24 adopts the aforementioned birefringent crystal B1. The polarization state of the light input from port one is o-light in the first birefringent crystal 22 and e-light in second birefringent crystal 24 along the first direction.

The polarization-maintaining optical circulator 100 in this embodiment is used to transmit the light input from port one to port two in the first direction, transmit the light input from port two to port three in the second direction, transmit the light input from port three to port four in the first direction, and transmit the light input from port four to port one in the second direction, with the first direction and the second direction being opposite.

The polarization-maintaining optical circulator includes: a first double-core polarization-maintaining waveguide 21 configured to provide port one and port three, a first birefringent crystal 22, a first Faraday rotator 23, a lens 25, a second birefringent crystal 24, a second double-core polarization-maintaining waveguide 26 configured to provide port two and port four that are successively arranged along the first direction. The first birefringent crystal 22, the first Faraday rotator 23, and the second birefringent crystal 24 are all parallel plate structures.

### 1. From Port One to Port Two:

Port one is configured to input divergent linearly polarized light with a fixed polarization direction. The light input from port one enters the first birefringent crystal 22 as o-light (This embodiment takes o-light for illustration, but it can also be e-light). The first birefringent crystal 22 is configured to form a first crystal forward displacement of the light input from port one and then output it to the first Faraday rotator 23. The first Faraday rotator 23 is configured to rotate the polarization state of the light input from port one by an angle of α (45°) in the first rotation direction and then output it to the lens 25. The lens 25 is configured to converge the light input from port one and then output it to the second birefringent crystal 24. The second birefringent crystal 24 is configured to form a second crystal forward displacement of the light input from port one and then output it to port two. Port two is configured to output the light input from port one, achieving the transmission of light from port one to port two.

### 2. From Port Two to Port Three:

Port two is configured to input divergent linearly polarized light with a fixed polarization direction which is the same o-light or e-light as that of light input from port one, and then output it to the second birefringent crystal 24. The second birefringent crystal 24 is configured to create a second crystal backward displacement for the light input from port two and output it to the lens 25. lens 25 is configured to converge the light input from port two and output it to the first Faraday rotator 23. The first Faraday rotator 23 is configured to rotate the polarization state of the light input from port two by an angle α (45°) in the first rotation direction and output it to the first birefringent crystal 22. The first birefringent crystal 22 is configured to create a first crystal backward displacement for the light input from port two, and then output to port three. The polarization state of the light input from port two is rotated by 90° relative to the polarization state of the light input from port one in the first birefringent crystal 22, causing the light input from port two to deviate from the light input from port one due to the transformation of the o-light and e-light in the first birefringent crystal 22. The walk-off between the light input from port one and the light input from port two is equal to the separation of two cores of the first dual-core waveguide 21, allowing the light input from port two to couple into port three. port three is configured to output the light input from port two, achieving the transmission of light from port two to port three.

### 3. From Port Three to Port Four:

Port three is configured to input divergent linearly polarized light with a fixed polarization direction which is the same o-light or e-light as that of light input from port two, and then output it to the first birefringent crystal 22. The first birefringent crystal 22 is configured to form a first crystal forward displacement of the light input from port three and then output it to the first Faraday rotator 23. The first Faraday rotator 23 is configured to rotate the polarization state of the light input from port three by an angle of α (45°) in the first rotation direction and then output it to the lens 25. The lens 25 is configured to converge the light input from port three and then output it to the second birefringent crystal 24. The second birefringent crystal 24 is configured to form a second crystal forward displacement of the light input from port three and then output it to port four. The polarization state of the light input from port three is rotated by 90° relative to the polarization state of the light input from port two in the second birefringent crystal 24, causing the light input from port three to deviate from the light input from port two due to the transformation of the o-light and e-light in the second birefringent crystal 24. The walk-off between the light input from port two and the light input from port three is equal to the separation of two cores of the second dual-core waveguide 26, allowing the light input from port three to couple into port four. port four is configured to output the light input from port three, achieving the transmission of light from port three to port four.

### 4. From Port Four to Port One:

Port four is configured to input divergent linearly polarized light with a fixed polarization direction which is the same o-light or e-light as that of light input from port three, and then output it to the second birefringent crystal 24. The second birefringent crystal 24 is configured to create a second crystal backward displacement for the light input from port four and output it to the lens 25. lens 25 is configured to converge the light input from port four and output it to the first Faraday rotator 23. The first Faraday rotator 23 is configured to rotate the polarization state of the light input from port four by an angle α (45°) in the first rotation direction and output it to the first birefringent crystal 22. The first birefringent crystal 22 is configured to create a first crystal backward displacement for the light input from port four, and then output to port one. The polarization state of the light input from port four is rotated by 90° relative to the polarization state of the light input from port three in the first birefringent crystal 22, causing the light input from port four to deviate from the light input from port three due to the transformation of the o-light and e-light in the first birefringent crystal 22. Now the polarization state of the light input from port four is same to the polarization state of the light input from port one, thus the light input from port four couples into port one in the backward direction of the light input from port one, achieving the transmission of light from port four to port one.

In this embodiment, the optical path from port one to port two and from port two to port three, as well as the changes in polarization state and displacement of the light, are same to Embodiment 1 and can refer to the aforementioned explanation of FIGS. 7 to 8. Below is an explanation to the light transmission from port three to port four and from port four to port one.

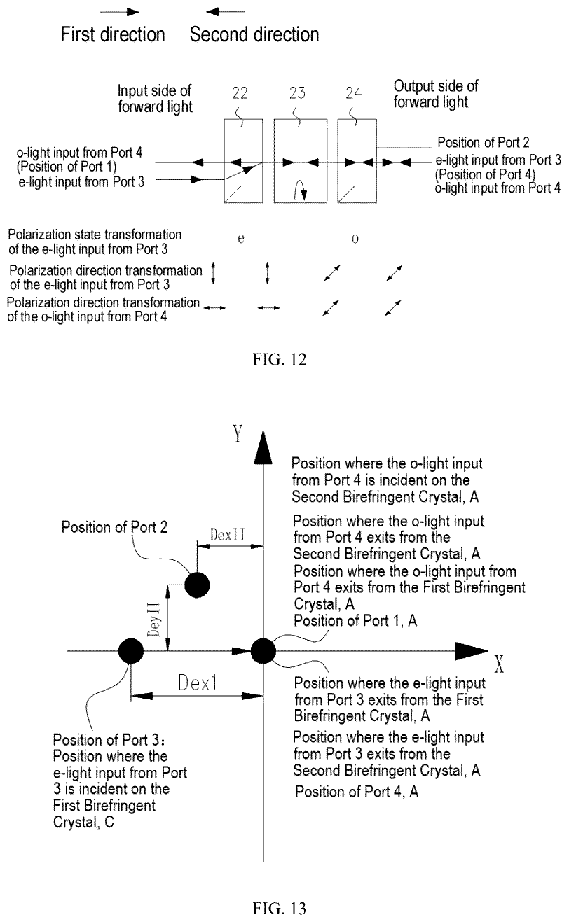

Please refer to FIG. 12 for the schematic diagram of the optical paths of e-light inputting from port three and o-light inputting from port four in the polarization-maintaining optical circulator according to Embodiment 2. The e-light input from port three will deviate in the first birefringent crystal 22 and exit from the output surface of the first birefringent crystal 22; then the polarization state of the light rotates by 45° and aligns with the o-light polarization state of the second birefringent crystal 24 after passing through the first Faraday rotator 23; the e-light input from port three will not deviate in the second birefringent crystal 24 and exit from the output surface of the second birefringent crystal 24 at the same xy coordinates as the incident surface. For the o-light input from port four, the optical path of the o-light input from port four coincides with that of the e-light input from port three between the input surface of the second birefringent crystal 24 and the output surface of the first Faraday rotator 23 along the second direction; however, the polarization state of the o-light input from port four rotates by 45° in the same direction as the e-light input from port three after passing through the first Faraday rotator 23, the o-light input from port four has accumulated a polarization rotation of 90° relative to the e-light input from port three. The polarization state of the o-light input from port four is perpendicular to the polarization state of the e-light input from port three in the first birefringent crystal 22, that means the transformation between the o-light and e-light. The polarization state of the o-light input from port four aligns with the o-light polarization state of the first birefringent crystal 22. Now the polarization state of the light input from port four is same to the polarization state of the light input from port one, thus the light input from port four couples into port one in the backward direction of the light input from port one, achieving the transmission of light from port four to port one.

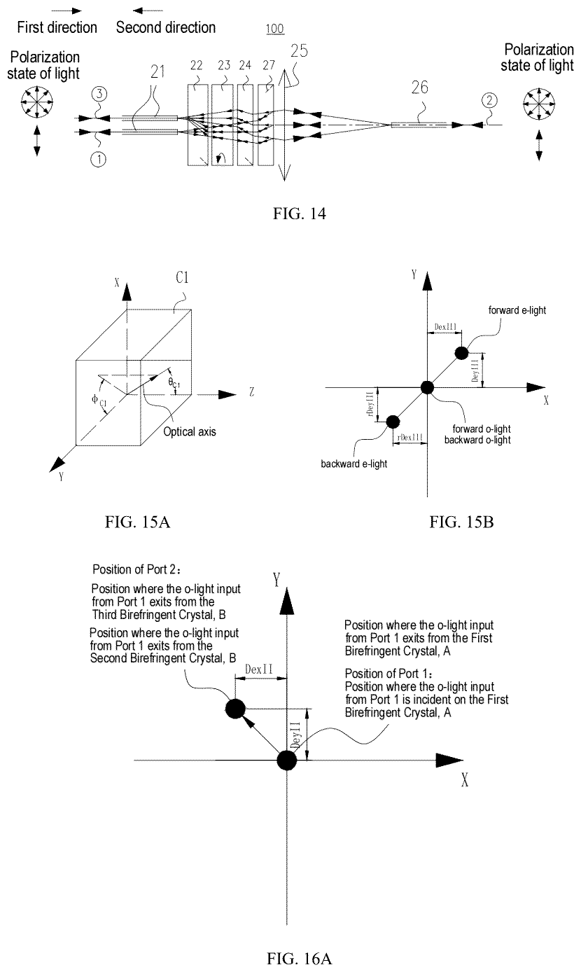

This embodiment also provides a schematic diagram of the projection positions of the beam's entry and exit points on the xy plane in each birefringent crystal as the optical path shown in FIG. 12. Refer to FIG. 13 for details. The e-light input from port three is incident on the first birefringent crystal 22 at point C and then generates the displacements of DexI=2a and DeyI=0 along the x-axis and γ-axis respectively, and exit at point A. The polarization state of the e-light input from port three rotates by 45° and aligns with the o-light polarization state of the second birefringent crystal 24 after passing through the first Faraday rotator 23, then the e-light input from port three still exits at point A and couples into port four without deviation in the second birefringent crystal 24. The o-light input from port four is incident on the second birefringent crystal 24 at point A and still exits at point A without deviation. The polarization state of the o-light input from port four aligns with the o-light polarization state of the first birefringent crystal 22 after passing through the first Faraday rotator 23, and then still exits at point A and couples into port one without deviation.

In summary, the incident point of the e-light input from port two in the second birefringent crystal 24 is point B (corresponding to the position of port two), and the exit point of the e-light input from port three in the second birefringent crystal 24 is point A (corresponding to the position of port four), the two cores of the second dual-core waveguide 26 are aligned with points B and A respectively, and the polarization states of the two cores are aligned with the e-light and o-light polarization states of the second birefringent crystal 24 respectively. The incident point of the e-light input from port three in the first birefringent crystal 22 is point C (corresponding to the position of port three), and the exit point of the o-light input from port four in the first birefringent crystal 22 is point A (corresponding to the position of port one), the two cores of the first dual-core waveguide 21 are aligned with points A and C, respectively, and the polarization states of the two cores are aligned with the o-light and e-light polarization states of the first birefringent crystal 22 respectively.

Based on the aforementioned sequential coupling of light inputs from each port into the next port, it can be similarly known that the light inputs from each port cannot couple into the previous port, thus achieving backward isolation from each port to the previous one.

In other embodiments, the arrangement of the optical path are the same as in the aforementioned Embodiment 2, the only difference is that the φ angle of the birefringent crystals and/or the rotation direction of the Faraday is changed and make the polarization state of the o-light input from port one as o-o in the first birefringent crystal 22 and in the second birefringent crystal 24, or the polarization state of the e-light input from port one as e-o in the first birefringent crystal 22 and in the second birefringent crystal 24, or the polarization state of the e-light input from port one as e-e in the first birefringent crystal 22 and in the second birefringent crystal 24. By reasonably setting the φ angle and the relative displacement between o-light and e-light of the first birefringent crystal 22 and the second birefringent crystal 24, and the polarization-state relationship of o-light and e-light between the birefringent crystals, and then matching the dual-core spacing and polarization direction of the dual-core polarization-maintaining waveguide, the optical circulating and backward isolation functions can also be achieved too. The specific changes in polarization state and beam displacement are similar and will not be further elaborated here.

### Embodiment 3

FIG. 14 is a schematic diagram of the optical path of a 3-port optical circulator with non-fully polarization-maintaining input/output waveguide and single-stage isolation function according to Embodiment 3 of the present disclosure. In this embodiment, port one is a polarization-maintaining port, port two is either a polarization-maintaining port or a non-polarization-maintaining port, and port three is either a polarization-maintaining port or a non-polarization-maintaining port.

Firstly, based on the aforementioned birefringent crystals A1 and B1, another birefringent crystal C1 is illustrated. Please refer to FIGS. 15A and 15B for details, which illustratively show the structure and optical axis of the birefringent crystal C1. As shown in FIG. 15A, birefringent crystal C1 is a parallel plate structure, a three-dimensional Cartesian coordinate system is established with the incidence surface of the light input from port one as the xy plane where the x axis and y axis are located, and the first direction as the positive direction of z-axis, where the normal to the incidence surface of birefringent crystal C1 of the light input from port one is parallel to the z-axis. The angle θC1 between the optical axis of birefringent crystal C1 and the normal to the incidence surface of the light input from port one (i.e., the z-axis) is its walk-off angle. The angle φC1 between the y-axis and the line where the e-light oscillation plane through the optical axis of birefringent crystal C1 intersects the xy plane is φC1=45° in FIG. 15A. FIG. 15B shows a diagram of the light displacement in birefringent crystal C1, the Cartesian coordinate system establishment and reference is in the same way as aforementioned birefringent crystals A1 and B1, and the same applies to the following text, which will not be further elaborated here. As shown in FIG. 15B, the forward o-light displacement in the x-axis direction of birefringent crystal C1 is DoxIII=0, and the forward o-light displacement in the y-axis direction is DoyIII=0; the forward e-light displacement in the x-axis direction of birefringent crystal C1 is DexIII=a, and the forward e-light displacement in the y-axis direction is DeyIII=) a/tan (45°)=a; the backward o-light displacement in the x-axis direction of birefringent crystal C1 is rDoxIII=0, and the backward o-light displacement in the y-axis direction is rDoyIII=0; the backward e-light displacement in the x-axis direction of birefringent crystal C1 is rDexIII=−a, and the backward e-light displacement in the y-axis direction is rDeyIII=−a/tan (45°)=−a. Of course, other displacement values can be adopted according to specific situations, and this is not limited here.

In addition to the structure shown in FIG. 3, the polarization-maintaining optical circulator of this embodiment also includes a third birefringent crystal 27, which is arranged between the second birefringent crystal 24 and the lens 25 along the first direction. The third birefringent crystal 27 is a parallel plate structure. Light input from port one forms a third crystal forward displacement within the third birefringent crystal 27, and light input from port two forms a third crystal backward displacement within the third birefringent crystal 27, thereby achieving a polarization-maintaining optical circulator with single-stage isolation function.

In this embodiment, the first birefringent crystal 22 adopts the aforementioned birefringent crystal A1, and the second birefringent crystal 24 adopts the aforementioned birefringent crystal B1, and the third birefringent crystal 27 adopts the aforementioned birefringent crystal C1. The details refer to the aforementioned text and will not be further elaborated here. The polarization state of the light input from port one is o-light in the first birefringent crystal 22, e-light in second birefringent crystal 24 and o-light in third birefringent crystal 27 along the first direction.

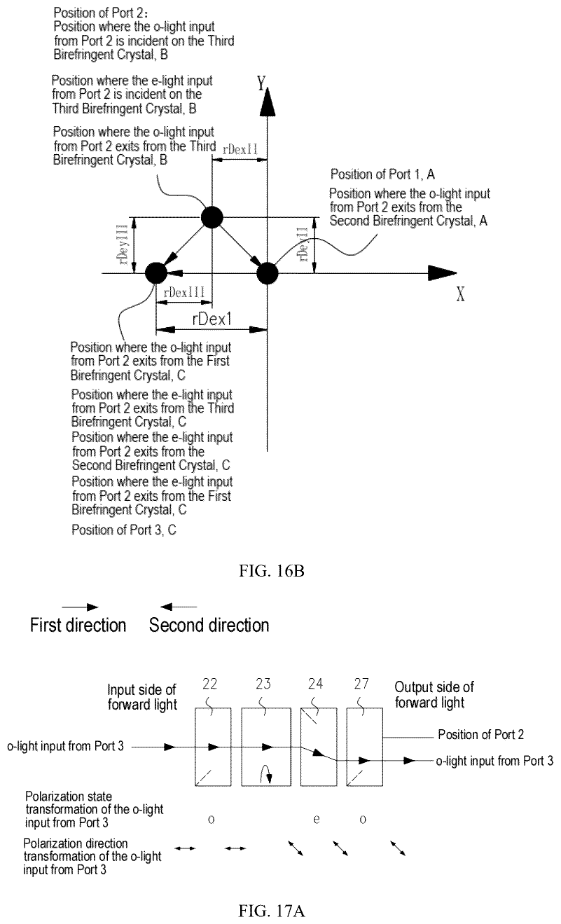

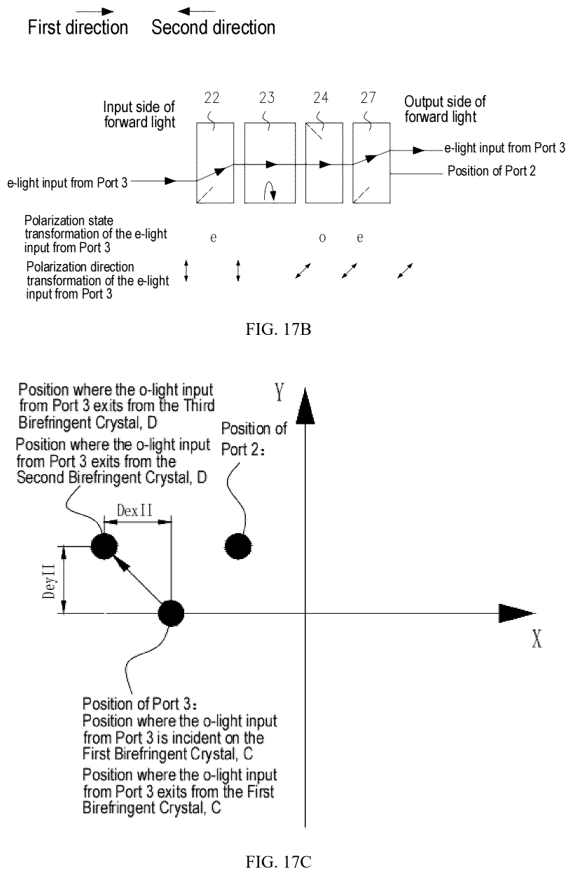

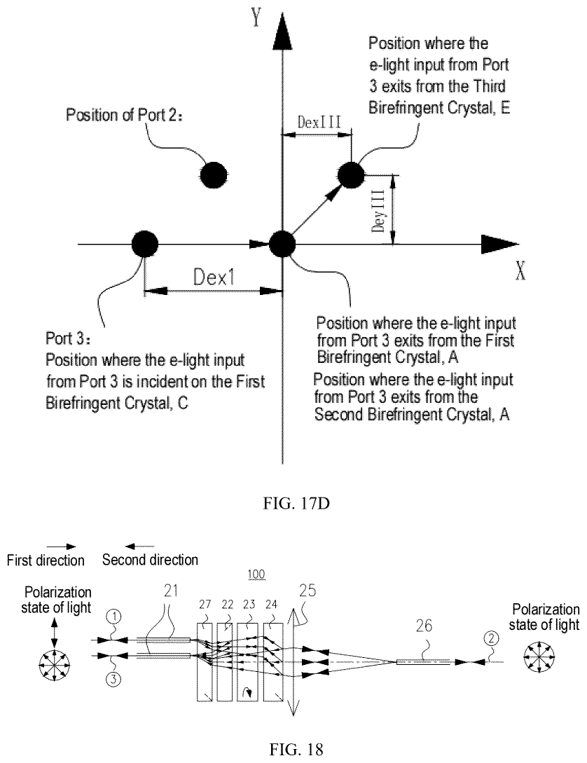

In the polarization-maintaining optical circulator provided by Embodiment 3 of present disclosure, please refer to FIG. 16A for the schematic diagram of the displacement of the o-light input in the first birefringent crystal 22 from port one and exited from port two; refer to FIG. 16B for the schematic diagram of the displacement of the o-light and e-light input on the third birefringent crystal 27 from port two and exited from port three. The port one and port three of the first dual-core waveguide 21 are aligned with points A and C respectively, and the polarization states of the two cores are aligned with the o-light and e-light polarization states of the first birefringent crystal 22 respectively, then achieving the sequential coupling from port one to port two and from port two to port three. Please refer to FIG. 17A for the schematic diagram of the optical path of the o-light input from port three; refer to FIG. 17B for the schematic diagram of the optical path of e-light input from port three. Refer to FIG. 17C for the schematic diagram of the displacement and isolation function of the o-light input in the first birefringent crystal 22 from port three to port two; refer to FIG. 17D for the schematic diagram of the displacement and isolation function of the e-light input in the first birefringent crystal 22 from port three to port two; the exit points D and E of o-light and e-light input from port three are both deviated from point B where port two is located, the backward isolation function from port three to port two is achieved. The content shown in the figures and the related principles are consistent with the explanations in the aforementioned Embodiment 1, and will not be further elaborated here.

The angle θ3 between the normal to the incidence surface of the light input from port one and the optical axis of the third birefringent crystal 27 is the third walk-off angle, with −90°<θ3<0° or 0°<θ3<90°. The third walk-off angle is configured to control the third crystal forward displacement and the third crystal backward displacement. An xyz coordinate system is established with the first direction of the optical path as the positive direction of z-axis. The e-light oscillation plane through the optical axis of the second birefringent crystal 24 intersects the xy plane at the second line, and the angle between the second line and the y-axis is φ2. The e-light oscillation plane through the optical axis of the third birefringent crystal 27 intersects the xy plane at the third line, and the angle between the third line and the y-axis is φ3. The relationship is set as |φ3−φ2|=90° or 270° which is configured to couple the arbitrary-polarization-state light input from port two into the port three.

Please refer to the explanation about φC1 of the birefringent crystal C in FIG. 15A for the details of φ3. By setting the relationship between φ1 and φ2 to |φ2−φ1|=(90°±α) or |φ2−φ1|=(270°±α), and the relationship between φ3 and φ2 to |φ3−φ2|=90° or 270°, it is ensured that the polarization state of the light exited from the first birefringent crystal 22 can align with the o-light or e-light of the second birefringent crystal 24 after passing through the first Faraday rotator 23, and achieve an o-e transformation or an e-o transformation on the polarization state between the second birefringent crystal 24 and the third birefringent crystal 27 when the light inputs into the third birefringent crystal 27. Above φ3=45° and φ2=315° satisfy the condition |φ3−φ2|=90° or 270°.

In other embodiments, the arrangement of the optical path are the same as in the aforementioned Embodiment 3, the only difference is that the φ angle of the birefringent crystals and/or the rotation direction of the Faraday is changed and make the polarization state of the o-light input from port one as o-o-e in the first birefringent crystal 22—the second birefringent crystal 24—the third birefringent crystal 27, or the polarization state of the e-light input from port one as e-o-e in the first birefringent crystal 22—the second birefringent crystal 24—the third birefringent crystal 27, or the polarization state of the e-light input from port one as e-e-o in the first birefringent crystal 22—the second birefringent crystal 24—the third birefringent crystal 27. By reasonably setting the φ angle and the relative displacement between o-light and e-light of the first birefringent crystal 22 and the second birefringent crystal 24 and the third birefringent crystal 27, and the polarization-state relationship of o-light and e-light between the birefringent crystals, and then matching the dual-core spacing and polarization direction of the dual-core polarization-maintaining waveguide, the optical circulating and backward single-stage isolation functions of the circulator can also be achieved too. The specific changes in polarization state and beam displacement are similar and will not be further elaborated here.

### Embodiment 4

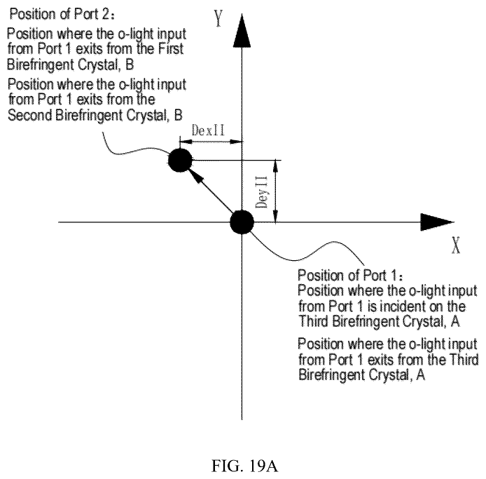

FIG. 18 is a schematic diagram of the optical path of another 3-port optical circulator with non-fully polarization-maintaining input/output waveguide and single-stage isolation function according to Embodiment 4 of the present disclosure. In this embodiment, port one is a polarization-maintaining port, port two is either a polarization-maintaining port or a non-polarization-maintaining port, and port three is either a polarization-maintaining port or a non-polarization-maintaining port. The difference between this embodiment and Embodiment 3 is the different position of the third birefringent crystal 27. Detailed descriptions are provided below.

In addition to the structure shown in FIG. 3, the polarization-maintaining optical circulator of this embodiment also includes a third birefringent crystal 27, which is arranged between the first dual-core waveguide 21 and the first birefringent crystal 22. The third birefringent crystal 27 is a parallel plate structure. Light input from port one forms a third crystal forward displacement within the third birefringent crystal 27, and light input from port two forms a third crystal backward displacement within the third birefringent crystal 27.

In this embodiment, the first birefringent crystal 22 adopts the aforementioned birefringent crystal B1, and the second birefringent crystal 24 adopts the aforementioned birefringent crystal A1, and the third birefringent crystal 27 adopts the aforementioned birefringent crystal C1. The polarization state of the light input from port one is o-light in third birefringent crystal 27, e-light in the first birefringent crystal 22 and o-light in second birefringent crystal 24 along the first direction.

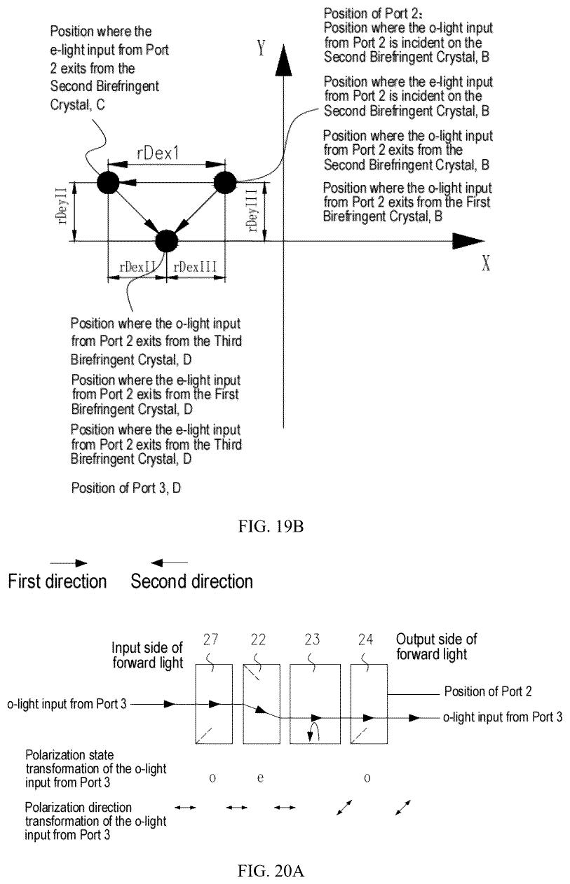

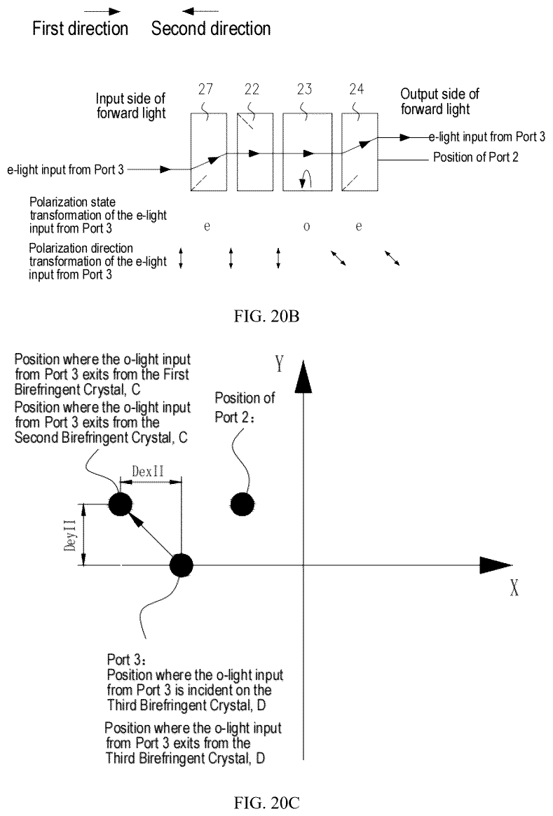

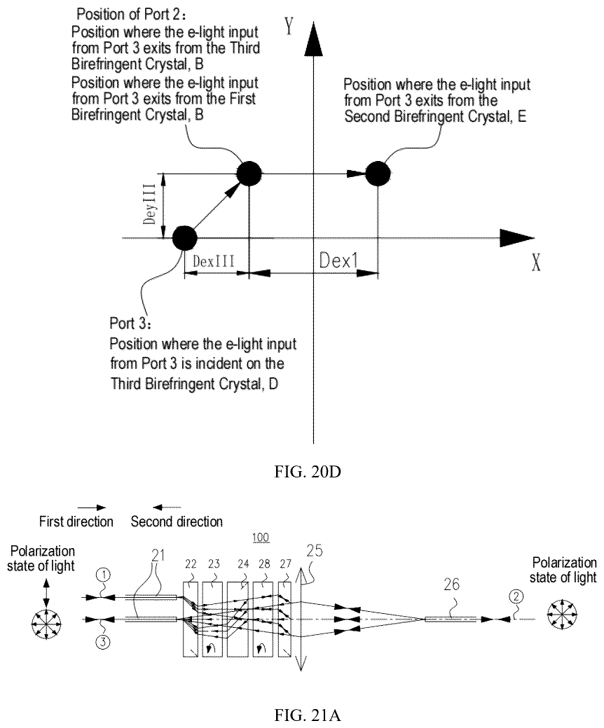

In the polarization-maintaining optical circulator provided by Embodiment 4 of present disclosure, please refer to FIG. 19A for the schematic diagram of the displacement of the o-light input in the third birefringent crystal 27 from port one and exited from port two; refer to FIG. 19B for the schematic diagram of the displacement of the o-light and e-light input on the second birefringent crystal 24 from port two and exited from port three. The port one and port three of the first dual-core waveguide 21 are aligned with points A and D respectively, and the polarization states of the two cores are aligned with the o-light and e-light polarization states of the third birefringent crystal 27 respectively, then achieving the sequential coupling from port one to port two and from port two to port three. Please refer to FIG. 20A for the schematic diagram of the optical path of the o-light input from port three; refer to FIG. 20B for the schematic diagram of the optical path of e-light input from port three. Refer to FIG. 20C for the schematic diagram of the displacement and isolation function of the o-light input in the third birefringent crystal 27 from port three to port two; refer to FIG. 20D for the schematic diagram of the displacement and isolation function of the e-light input in the third birefringent crystal 27 from port three to port two; the exit points C and E of o-light and e-light input from port three are both deviated from point B where port two is located, the backward isolation function from port three to port two is achieved. The content shown in the figures and the related principles are consistent with the explanations in the aforementioned Embodiment 1, and will not be further elaborated here.

The angle θ3 between the normal to the incidence surface of the light input from port one and the optical axis of the third birefringent crystal 27 is the third walk-off angle, with −90°<θ3<0° or 0°<θ3<90°. The third walk-off angle is configured to control the third crystal forward displacement and the third crystal backward displacement.

An xyz coordinate system is established with the first direction of the optical path as the positive direction of z-axis. The e-light oscillation plane through the optical axis of the first birefringent crystal 22 intersects the xy plane at the first line, and the angle between the first line and the y-axis is φ1. The e-light oscillation plane through the optical axis of the third birefringent crystal 27 intersects the xy plane at the third line, and the angle between the third line and the y-axis is φ3. The relationship is set as |φ3−φ1|=90° or 270° which is configured to couple the arbitrary-polarization-state light input from port two into the port three.

Please refer to the explanation about C1 of the birefringent crystal C in FIG. 15A for the details of φ3. By setting the relationship between φ1 and φ2 to |φ2−φ1|=(90°±α) or |φ2-φ1|=(270°±α), and the relationship between φ3 and φ1 to |φ3−φ1|=90° or 270°, it is ensured that an o-e transformation or an e-o transformation on the polarization state between the third birefringent crystal 27 and the first birefringent crystal 22 is achieved when the light inputs into the first birefringent crystal 22 along the first direction; and the polarization state of the light exited from the first birefringent crystal 22 can align with the o-light or e-light of the second birefringent crystal 24 after passing through the first Faraday rotator 23. Above φ3=45° and φ1=315° satisfy the condition |φ3−φ1|=90° or 270°.

In other embodiments, the arrangement of the optical path are the same as in the aforementioned Embodiment 4, the only difference is that the φ angle of the birefringent crystals and/or the rotation direction of the Faraday is changed and make the polarization state of the o-light input from port one as o-e-e in the third birefringent crystal 27—the first birefringent crystal 22—the second birefringent crystal 24, or the polarization state of the e-light input from port one as e-o-e in the third birefringent crystal 27—the first birefringent crystal 22—the second birefringent crystal 24, or the polarization state of the e-light input from port one as e-o-o in the third birefringent crystal 27—the first birefringent crystal 22—the second birefringent crystal 24. By reasonably setting the φ angle and the relative displacement between o-light and e-light of the first birefringent crystal 22 and the second birefringent crystal 24 and the third birefringent crystal 27, and the polarization-state relationship of o-light and e-light between the birefringent crystals, and then matching the dual-core spacing and polarization direction of the dual-core polarization-maintaining waveguide, the optical circulating and backward single-stage isolation functions of the circulator can also be achieved too. The specific changes in polarization state and beam displacement are similar and will not be further elaborated here.

### Embodiment 5

The backward isolation function achieved by the three birefringent crystals (the first birefringent crystal 22, the second birefringent crystal 24, and the third birefringent crystal 27) and a Faraday rotator (i.e., the first Faraday rotator 23) is referred to as single-stage isolation. To achieve better isolation, the number of Faraday rotators can be increased to form a dual-stage isolation.

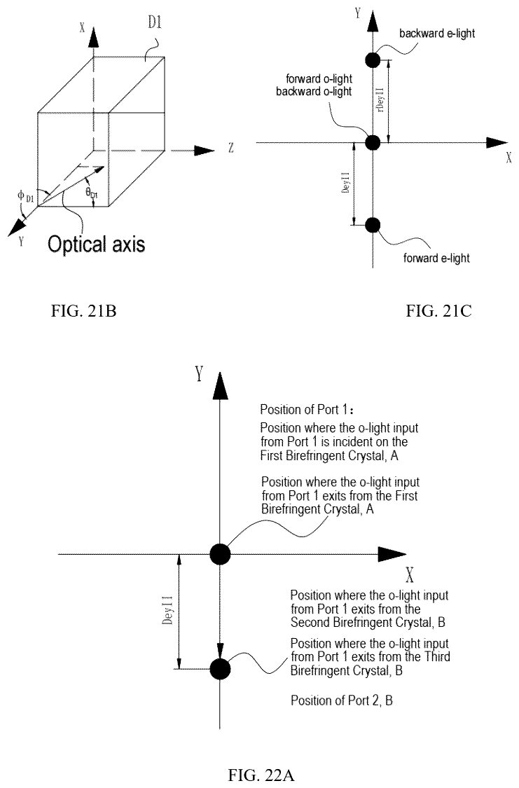

FIG. 21A is a schematic diagram of the optical path of a 3-port optical circulator with non-fully polarization-maintaining input/output waveguide and dual-stage isolation function according to Embodiment 5 of the present disclosure;

In this embodiment, port one is a polarization-maintaining port, port two is either a polarization-maintaining port or a non-polarization-maintaining port, and port three is either a polarization-maintaining port or a non-polarization-maintaining port.

Firstly, another birefringent crystal D1 is adopted in this embodiment, please refer to FIGS. 21B and 21C for detailed explanation, which illustratively show the structure and optical axis of the birefringent crystal D1. As shown in FIG. 21B, birefringent crystal D1 is a parallel plate structure, a three-dimensional Cartesian coordinate system is established with the incidence surface of the light input from port one as the xy plane where the x axis and y axis are located, and the first direction as the positive direction of z-axis, where the normal to the incidence surface of birefringent crystal D1 of the light input from port one is parallel to the z-axis. The angle θD1 between the optical axis of birefringent crystal D1 and the normal to the incidence surface of the light input from port one (i.e., the z-axis) is its walk-off angle. The angle between the y-axis and the line where the e-light oscillation plane through the optical axis of birefringent crystal D1 intersects the xy plane is φD1, φD1=180° in FIG. 21B. FIG. 21C shows a diagram of the light displacement in birefringent crystal D1, the Cartesian coordinate system establishment and reference is in the same way as aforementioned birefringent crystals A1 and B1, and the same applies to the following text, which will not be further elaborated here. As shown in FIG. 21C, the forward o-light displacement in the x-axis direction of birefringent crystal D1 is DoxII=0, and the forward o-light displacement in the y-axis direction is DoyII=0; the forward e-light displacement in the x-axis direction of birefringent crystal D1 is DexII=0, and the forward e-light displacement in the y-axis direction is DeyII=−2a; the backward o-light displacement in the x-axis direction of birefringent crystal D1 is rDoxII=0, and the backward o-light displacement in the y-axis direction is rDoyII=0; the backward e-light displacement in the x-axis direction of birefringent crystal D1 is rDexII=0, and the backward e-light displacement in the y-axis direction is rDeyII=2a. Of course, other displacement values can be adopted according to specific situations, and this is not limited here.

In addition to the structure shown in FIG. 3, the polarization-maintaining optical circulator of this embodiment also includes a second Faraday rotator 28 and a third birefringent crystal 27 which is arranged between the second birefringent crystal 24 and the lens 25 along the first direction (i.e., on the basis of the embodiment 3 shown in FIG. 14, the second Faraday rotator 28 is added between the second birefringent crystal 24 and the third birefringent crystal 27). Both the second Faraday rotator 28 and the third birefringent crystal 27 are parallel plate structure. The second Faraday rotator 28 is configured to rotate the polarization state of the light input from port one by an angle α along the second rotation direction and then output it to the third birefringent crystal 27, and to rotate the polarization state of the light input from port two by an angle α along the second rotation direction and then output it to the second birefringent crystal 24. Light input from port one forms a third crystal forward displacement within the third birefringent crystal 27, and light input from port two forms a third crystal backward displacement within the third birefringent crystal 27.

In this embodiment, the first birefringent crystal 22 adopts the aforementioned birefringent crystal B1, and the second birefringent crystal 24 adopts the aforementioned birefringent crystal D1, and the third birefringent crystal 27 adopts the aforementioned birefringent crystal C1. The details refer to the aforementioned text and will not be further elaborated here. The polarization state of the light input from port one is o-light in the first birefringent crystal 22, e-light in second birefringent crystal 24 and o-light in third birefringent crystal 27 along the first direction.

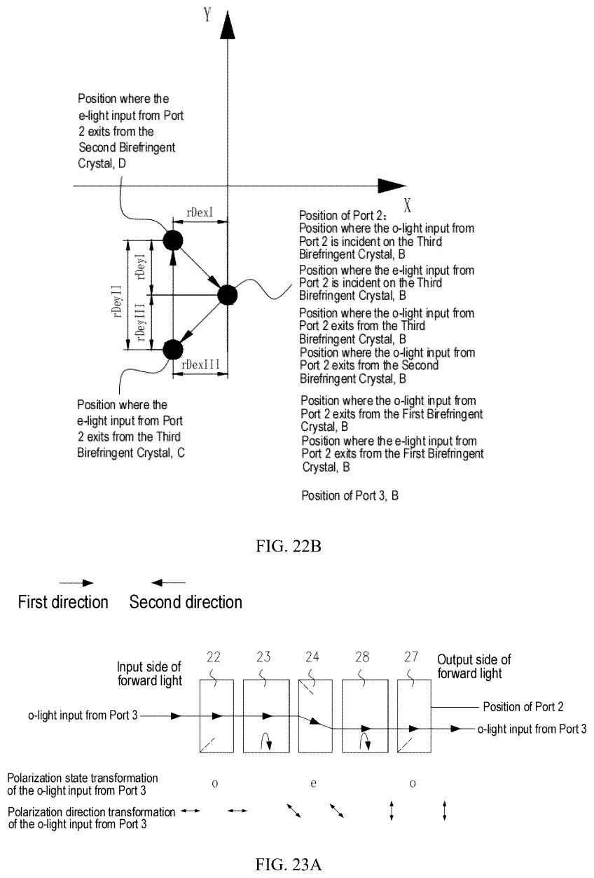

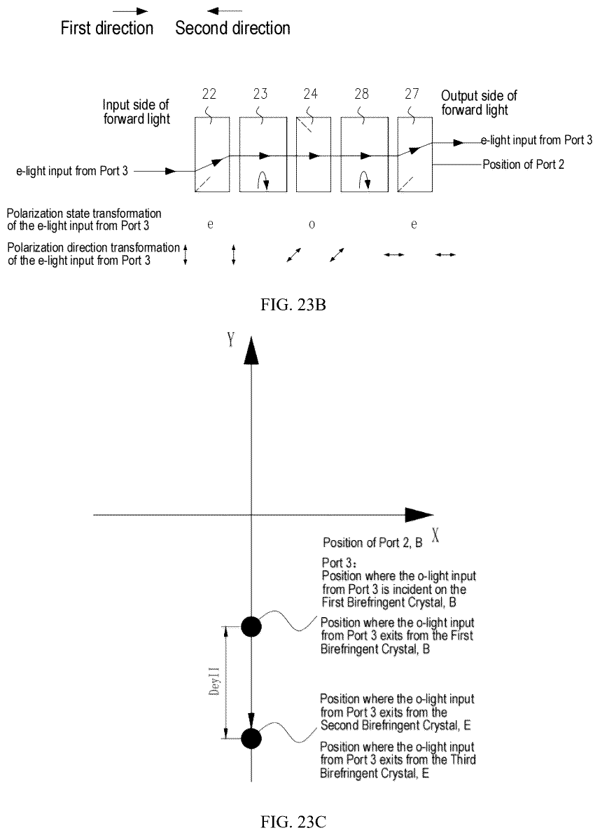

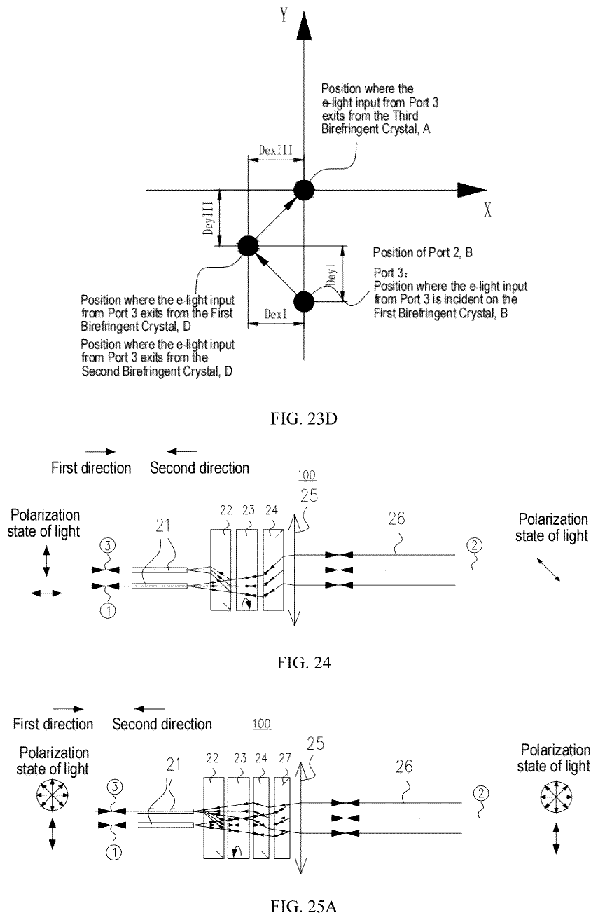

In the polarization-maintaining optical circulator provided by Embodiment 5 of present disclosure, please refer to FIG. 22A for the schematic diagram of the displacement of the o-light input in the first birefringent crystal 22 from port one and exited from port two; refer to FIG. 22B for the schematic diagram of the displacement of the o-light and e-light input on the third birefringent crystal 27 from port two and exited from port three. The port one and port three of the first dual-core waveguide 21 are aligned with points A and B respectively, and the polarization states of the two cores are aligned with the o-light and e-light polarization states of the first birefringent crystal 22 respectively, then achieving the sequential coupling from port one to port two and from port two to port three. Please refer to FIG. 23A for the schematic diagram of the optical path of the o-light input from port three; refer to FIG. 23B for the schematic diagram of the optical path of e-light input from port three. Refer to FIG. 23C for the schematic diagram of the displacement and isolation function of the o-light input in the first birefringent crystal 22 from port three to port two; refer to FIG. 23D for the schematic diagram of the displacement and isolation function of the e-light input in the first birefringent crystal 22 from port three to port two; the exit points E and A of o-light and e-light input from port three are both deviated from point B where port two is located, the backward isolation function from port three to port two is achieved. The content shown in the figures and the related principles are consistent with the explanations in the aforementioned Embodiment 1, and will not be further elaborated here.

The angle θ3 between the normal to the incidence surface of the light input from port one and the optical axis of the third birefringent crystal 27 is the third walk-off angle, with −90°<θ3<0° or 0°<θ3<90°. The third walk-off angle is configured to control the third crystal forward displacement and the third crystal backward displacement.

An xyz coordinate system is established with the first direction of the optical path as the positive direction of z-axis. The e-light oscillation plane through the optical axis of the second birefringent crystal 24 intersects the xy plane at the second line, and the angle between the second line and the y-axis is φ2. The e-light oscillation plane through the optical axis of the third birefringent crystal 27 intersects the xy plane at the third line, and the angle between the third line and the y-axis is φ3. The relationship is set as |φ3−φ2|=α, 90°+α, 180°+α or 270°+α, the φ2=180° and φ3=45° in this embodiment satisfy the above condition. Third birefringent crystal 27 is configured to couple the arbitrary-polarization-state light input from port two into the port three.

For the specific implementation of dual-stage isolation, please refer to FIGS. 21A, 23A, and 23B. The arbitrary-polarization-state light input from port three enters the first birefringent crystal 22. The first birefringent crystal 22 is configured to separate the arbitrary-polarization-state light input from port three into orthogonally polarized port-three incident o-light and port-three incident e-light, and form the first crystal forward displacement of both the port-three incident o-light and the port-three incident e-light, and then output to the first Faraday rotator 23. The first Faraday rotator 23 is configured to rotate the polarization states of the port-three incident o-light and the port-three incident e-light by an angle α (45°) in the first rotation direction and then output to the second birefringent crystal 24. The second birefringent crystal 24 is configured to generate a second crystal forward displacement of the port-three incident o-light and the port-three incident e-light, and then output to the second Faraday rotator 28. In the optical path between the first birefringent crystal 22, the first Faraday rotator 23, and the second birefringent crystal 24, the polarization states of the port-three incident o-light and the port-three incident e-light in the second birefringent crystal 24 are rotated by 90° relative to the port-two incident o-light and the port-two incident e-light, with the o-light and e-light undergoing transformation. This causes the optical paths of the port-three incident o-light and the port-three incident e-light to deviate from the optical paths of the port-two incident o-light and the port-two incident e-light in the second birefringent crystal 24, achieving the first-stage isolation from port three to port two. The second Faraday rotator 28 is configured to rotate the polarization states of the port-three incident o-light and the port-three incident e-light by an angle α (45°) in the second rotation direction and then output to the third birefringent crystal 27. The third birefringent crystal 27 is configured to generate a third crystal forward displacement of the port-three incident o-light and the port-three incident e-light. In the optical path between the second birefringent crystal 24, the second Faraday rotator 28, and the third birefringent crystal 27, for the port-three incident light and the port-two incident light with the same polarization state (o-light polarization state or e-light polarization state) in the second birefringent crystal 24, the port-three incident light transmitted in the first direction passes through the second Faraday rotator 28 and is rotated by α (45°) in the second rotation direction, its polarization state is cumulatively rotated by 90° relative to the polarization state of the port-two incident light transmitted in the second direction in the third birefringent crystal 27, the o-light and e-light undergo transformation, the port-three incident light which has the same polarization state with the port-two incident light in the second birefringent crystal 24 deviates again from the optical path of the port-two incident light in the third birefringent crystal 27, achieving the second-stage isolation from port three to port two. The sum of the first Crystal forward displacement and the second Crystal forward displacement and the third Crystal forward displacement causes the o-light and e-light input from port three and output from the third birefringent crystal 27 deviates from the optical path of the light input from port two, and cannot couple into the single-core waveguide 26 after converging by lens 25, achieving the dual-stage isolation function from port three to port two.

Based on the aforementioned sequential coupling of light inputs from each port into the next port, it can be similarly known that the light inputs from port two cannot couple into port one, thus achieving backward isolation from port two to port one.

In other embodiments, the arrangement of the optical path are the same as in the aforementioned Embodiment 5, the only difference is that the q angle of the birefringent crystals and/or the rotation direction of the Faraday is changed and make the polarization state of the o-light input from port one as o-o-e in the first birefringent crystal 22—the second birefringent crystal 24—the third birefringent crystal 27, or the polarization state of the o-light input from port one as o-o-o in the first birefringent crystal 22—the second birefringent crystal 24—the third birefringent crystal 27, or the polarization state of the o-light input from port one as o-e-e in the first birefringent crystal 22—the second birefringent crystal 24—the third birefringent crystal 27, or the polarization state of the e-light input from port one as e-o-e in the first birefringent crystal 22—the second birefringent crystal 24—the third birefringent crystal 27, or the polarization state of the e-light input from port one as e-e-o in the first birefringent crystal 22—the second birefringent crystal 24—the third birefringent crystal 27, or the polarization state of the e-light input from port one as e-e-e in the first birefringent crystal 22—the second birefringent crystal 24—the third birefringent crystal 27, or the polarization state of the e-light input from port one as e-o-o in the first birefringent crystal 22—the second birefringent crystal 24—the third birefringent crystal 27. By reasonably setting the q angle and the relative displacement between o-light and e-light of the first birefringent crystal 22 and the second birefringent crystal 24 and the third birefringent crystal 27, and the polarization-state relationship of o-light and e-light between the birefringent crystals, and then matching the dual-core spacing and polarization direction of the dual-core polarization-maintaining waveguide, the optical circulating and backward dual-stage isolation functions of the circulator can also be achieved too. The specific changes in polarization state and beam displacement are similar and will not be further elaborated here.

### Embodiment 6

FIG. 24 is a schematic diagram of the optical path of 3-port fully polarization-maintaining optical circulator with collimating beam output at port two according to Embodiment 6 of the present disclosure. The difference from Embodiment 1 is that port two outputs the collimating beam to free space in this embodiment instead of adopting a single-core waveguide. lens 25 is configured to collimate the light input from port one into collimating beam and output it to port two, where port two is configured to output this collimating beam; additionally, port two is configured to input collimating beam and output it to lens 25, lens 25 is also configured to focus the input collimating beam into a convergent beam and outputs it to port three. The rest of the optical path transmission and principle of this embodiment are similar to Embodiment 1, and reference can be made to the explanation of Embodiment 1.

### Embodiment 7

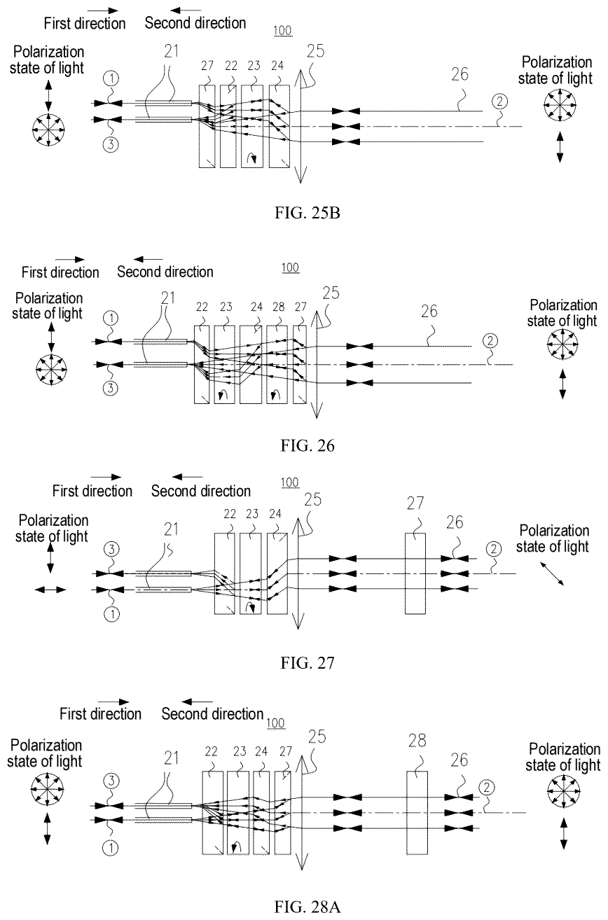

FIG. 25A is a schematic diagram of the optical path of a 3-port non-fully polarization-maintaining optical circulator with collimating beam output from port two and single-stage isolation function according to Embodiment 7 of the present disclosure. The difference from Embodiment 3 is that port two outputs the collimating beam to free space in this embodiment instead of adopting a single-core waveguide. lens 25 is configured to collimate the light input from port one into collimating beam and output it to port two, where port two is configured to output this collimating beam; additionally, port two is configured to input collimating beam and output it to lens 25, lens 25 is also configured to focus the input collimating beam into a convergent beam and outputs it to port three. The rest of the optical path transmission and principle of this embodiment are similar to Embodiment 3, and reference can be made to the explanation of Embodiment 3.

### Embodiment 8

FIG. 25B is a schematic diagram of the optical path of another 3-port non-fully polarization-maintaining optical circulator with collimating beam output from port two and single-stage isolation function according to Embodiment 8 of the present disclosure. The difference from Embodiment 4 is that port two outputs the collimating beam to free space in this embodiment instead of adopting a single-core waveguide. lens 25 is configured to collimate the light input from port one into collimating beam and output it to port two, where port two is configured to output this collimating beam; additionally, port two is configured to input collimating beam and output it to lens 25, lens 25 is also configured to focus the input collimating beam into a convergent beam and outputs it to port three. The rest of the optical path transmission and principle of this embodiment are similar to Embodiment 4, and reference can be made to the explanation of Embodiment 4.

### Embodiment 9

FIG. 26 is a schematic diagram of the optical path of a 3-port non-fully polarization-maintaining optical circulator with collimating beam output from port two and dual-stage isolation function according to Embodiment 9 of the present disclosure. The difference from Embodiment 5 is that port two outputs the collimating beam to free space in this embodiment instead of adopting a single-core waveguide. lens 25 is configured to collimate the light input from port one into collimating beam and output it to port two, where port two is configured to output this collimating beam; additionally, port two is configured to input collimating beam and output it to lens 25, lens 25 is also configured to focus the input collimating beam into a convergent beam and outputs it to port three. The rest of the optical path transmission and principle of this embodiment are similar to Embodiment 5, and reference can be made to the explanation of Embodiment 5.

### Embodiments 10-13

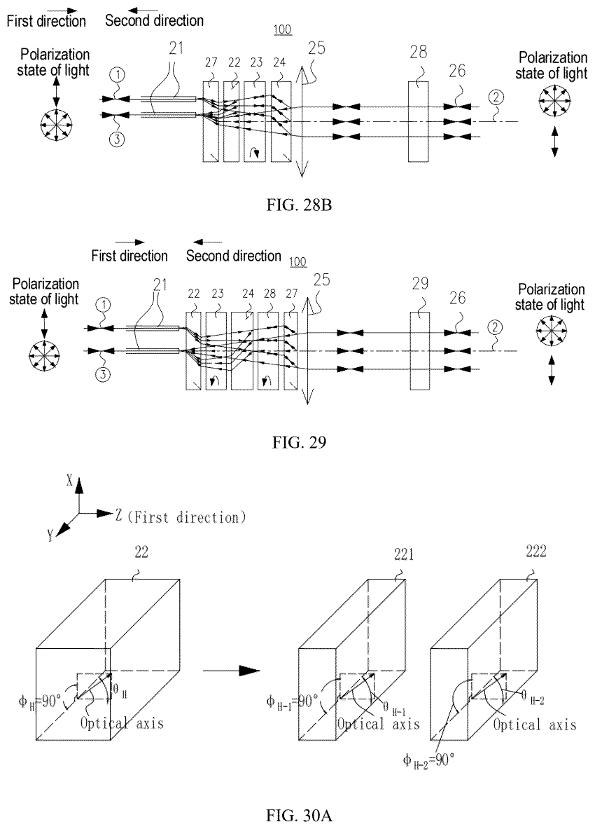

In some embodiments, a filter may additionally be placed at the focal point of lens 25 between the lens and port two. Please refer to FIG. 27-29, where FIG. 27 is a schematic diagram of the optical path of the polarization-maintaining optical circulator with an additional filter based on the embodiment shown in FIG. 24 according to Embodiment 10 of the present disclosure; FIG. 28A is a schematic diagram of the optical path of the polarization-maintaining optical circulator with an additional filter based on the embodiment shown in FIG. 25a according to Embodiment 11 of the present disclosure; FIG. 28B is a schematic diagram of the optical path of the polarization-maintaining optical circulator with an additional filter based on the embodiment shown in FIG. 25b according to Embodiment 12 of the present disclosure; FIG. 29 is a schematic diagram of the optical path of the polarization-maintaining optical circulator with an additional filter based on the embodiment shown in FIG. 26, according to Embodiment 13 of the present disclosure. In the illustrated embodiments, port two is configured to output or input collimating beam, and the polarization-maintaining optical circulator 100 further includes a filter located at the focal point of lens 25 between lens 25 and port two. The filter is configured to reflect all or part of the collimating beam output from port one to port two.

### Combined Crystals:

Please continue to refer to FIG. 3, where the o-light input from port one and the e-light input from port two have different refractive indices in the first birefringent crystal 22. Therefore, in the first birefringent crystal 22, the optical path of the o-light input from port one is not equal to the optical path of the e-light input from port two, resulting in an optical path difference. Similar situations also exist in other embodiments.

Thus, in some embodiments, the first birefringent crystal 22, and/or the second birefringent crystal 24, and/or the third birefringent crystal 27 is a combined crystal. The combined crystal is configured to form the same relative displacement and to compensate for the optical path difference.

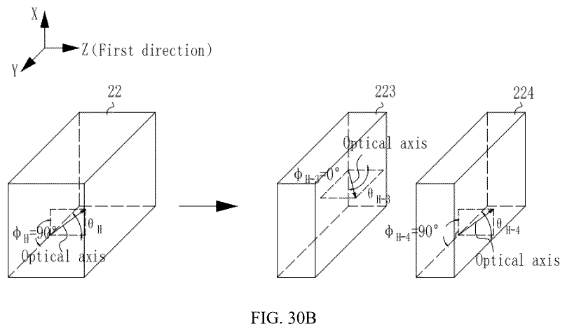

Specifically, refer to FIGS. 30A and 30b, they provide two exemplary explanations taking the first birefringent crystal 22 as a combined crystal. As shown in FIG. 30A, a coordinate system is established with the incidence surface as the x-y plane and the first direction of the optical path as the positive direction of z-axis, the first birefringent crystal 22 is composed of a sub-birefringent crystal 221 and a sub-birefringent crystal 222. The φH−1 of the sub-birefringent crystal 221 is the same as the φH−2 of the sub-birefringent crystal 222, and the sub-birefringent crystal 221 satisfies 0°<θH−1<90° and the sub-birefringent crystal 222 satisfies 0°<θH−2≤90°. The positions of sub-birefringent crystals 221 and 222 can be interchanged to achieve the same function. As shown in FIG. 30B, the first birefringent crystal 22 can also be composed of a sub-birefringent crystal 223 and a sub-birefringent crystal 224. The φ angles of sub-birefringent crystals 223 and 224 differ by 90° or 270°, and the sub-birefringent crystal 223 satisfies 0°<θH−3≤90° and the sub-birefringent crystal 224 satisfies 0°<θH−4<90°. The positions of sub-birefringent crystals 223 and 224 can be interchanged to achieve the same function. The same applies to the second birefringent crystal 24 and the third birefringent crystal 27, and will not be further elaborated here.

Taking the first birefringent crystal 22 as an example of a combined crystal, the sum of the relative displacements of the light input from port one in the two sub-birefringent crystals forms a displacement identical to the relative displacement between o-light and e-light in the aforementioned first birefringent crystal 22. The combined crystal can be configured to compensate for the optical path difference generated in a single birefringent crystal, or it can be configured to compensate for the optical path differences generated in multiple birefringent crystals along the entire optical path. When compensating for the optical path difference of a single crystal, it can be configured with the o-light and e-light polarization states interchanged in two sub-birefringent crystals that are either both positive birefringent crystals or both negative birefringent crystals, thereby reducing the total optical path difference. Alternatively, the two sub-birefringent crystals can consist of one positive birefringent crystal and one negative birefringent crystal with the same polarization state (both o-light or both e-light) maintained in two sub-birefringent crystals, thus reducing the optical path difference. By properly setting the θ angle and the thickness of the sub-birefringent crystals, the optical path difference between the o-light and e-light in each sub-birefringent crystal can be adjusted. When compensating for the optical path difference of the entire optical path, the sub-birefringent crystal used in the combined crystal to compensate for the optical path difference must not only achieve the same displacement change with the other sub-birefringent crystal in the combined crystal but also have its own optical path difference between o-light and e-light configured in the opposite direction to the sum of the optical path differences of the other birefringent crystals in the entire optical path. This reduces the total optical path difference and can even make the optical path difference zero, achieving the function of compensating for the optical path difference of the entire optical path.

Finally, it should be noted that the above embodiments are merely exemplary and do not limit the scope of present disclosure regarding the deviation of the optical path, the direction of deviation, and the distance of deviation. Based on the structure proposed in present disclosure, reasonable design of the structure and optical axis of the first birefringent crystal 22, the second birefringent crystal 24 and the third birefringent crystal 27, the rotation direction of the Faraday rotators, and the relationship between the polarization states of o-light and e-light, all schemes for realizing the optical circulator should be included within the scope of protection of present disclosure.

What is claimed is:

1. A polarization-maintaining optical circulator, the polarization-maintaining optical circulator transmits the light input from port one to port two in the first direction and the light input from port two to port three in the second direction, the first direction and second direction being opposite to each other; the polarization-maintaining optical circulator comprising: a dual-core waveguide configured to provide port one and port three, a first birefringent crystal, a first Faraday rotator, a second birefringent crystal, a lens and a port two that are successively arranged along the first direction; the first birefringent crystal, the first Faraday rotator, and the second birefringent crystal are all parallel plate structures; wherein,
the port one is a polarization-maintaining port and configured to input divergent linearly polarized light and the light input from port one enters the first birefringent crystal as o-light or e-light;
the first birefringent crystal is configured to form a first crystal forward displacement of the light input from port one, and then output it to the first Faraday rotator;
the first Faraday rotator is configured to rotate the polarization direction of the light input from port one by an angle of α in the first rotation direction and then output it to the second birefringent crystal, where α=45°;
the second birefringent crystal is configured to form a second crystal forward displacement of the light input from port one, and then output it to the lens;
the lens is configured to optically shape the light input from port one and output it to the port two;
the port two is configured to output the light input from port one to realize the transmission from port one to port two;
the port two is further configured to input light and then output it to the lens;
the lens is further configured to optically converge the light input from port two and output it to the second birefringent crystal;
the second birefringent crystal is further configured to form a second crystal backward displacement of the light input from port two, and then output it to the first Faraday rotator;
the first Faraday rotator is further configured to rotate the polarization direction of the light input from port two by an angle of α in the first rotation direction and then output it to the first birefringent crystal;
the first birefringent crystal is further configured to form a first crystal backward displacement of the light input from port two, and then output it to the port three; wherein, the polarization state of the light input from port two undergoes a 90° rotation in the first birefringent crystal relative to the light input from port one, causing the light input from port two to deviate from the light input from port one due to the transformation of the o-light and e-light in the first birefringent crystal; the walk-off between the light input from port one and the light input from port two being equal to the separation of two cores of the dual-core waveguide, allowing the light input from port two to couple into port three;
the port three is configured to output the light input from port two to realize the transmission from port two to port three.

2. The polarization-maintaining optical circulator according to claim 1, wherein the angle θ1 between the normal to the incidence surface of the light input from port one and the optical axis of the first birefringent crystal is the first walk-off angle, with −90°<θ1<0° or 0°<θ1<90°; the first walk-off angle being configured to control the first crystal forward displacement and the first crystal backward displacement; and/or,
the angle θ2 between the normal to the incidence surface of the light input from port one and the optical axis of the second birefringent crystal is the second walk-off angle, with −90°<θ2<0° or 0°<θ2<90°; the second walk-off angle being configured to control the second crystal forward displacement and the second crystal backward displacement;

3. The polarization-maintaining optical circulator according to claim 1, wherein, an xyz coordinate system is established with the first direction as the positive direction of z-axis;
the e-light oscillation plane through the optical axis of the first birefringent crystal intersects with the xy plane at the first line, and the angle between the first line and the y-axis is φ1;
the e-light oscillation plane through the optical axis of the second birefringent crystal intersects with the xy plane at the second line, and the angle between the second line and the y-axis is φ2;
wherein, |φ2−φ1|=(90°±α), or |φ2−φ1|=(270°±α).

4. The polarization-maintaining optical circulator according to claim 1, wherein along the first direction, the polarization state of the first birefringent crystal o-light aligns with the o-light or e-light polarization state of the second birefringent crystal after passing through the first Faraday rotator.

5. The polarization-maintaining optical circulator according to claim 1, wherein the port two and port three are both polarization-maintaining ports, the polarization state of port two is aligned with the polarization state of the light input from port one and output from the lens along the first direction, and the polarization state of port three is aligned with the polarization state of the light input from port two and output from the first birefringent crystal along the second direction.

6. The polarization-maintaining optical circulator according to claim 1, wherein the port two is polarization-maintaining port or non-polarization-maintaining port, and port three is polarization-maintaining port or non-polarization-maintaining port, the polarization-maintaining optical circulator further comprises a third birefringent crystal successively arranged between the second birefringent crystal and the lens along the first direction, the third birefringent crystal is parallel plate structures, the light input from port one forms a third crystal forward displacement in the third birefringent crystal, and the light input from port two forms a third crystal backward displacement in the third birefringent crystal;
the angle θ3 between the normal to the incidence surface of the light input from port one and the optical axis of the third birefringent crystal is the third walk-off angle, with −90°<θ3<0° or 0°<θ3<90°; the third walk-off angle being configured to control the third crystal forward displacement and the third crystal backward displacement;
an xyz coordinate system is established with the first direction as the positive direction of z-axis; the e-light oscillation plane through the optical axis of the second birefringent crystal intersects with the xy plane at the second line, and the angle between the second line and the y-axis is φ2; the e-light oscillation plane through the optical axis of the third birefringent crystal intersects with the xy plane at the third line, and the angle between the third line and the y-axis is φ3; wherein, |φ3−φ2|=90° or 270°, for coupling arbitrary polarization state of light input from port two into port three.

7. The polarization-maintaining optical circulator according to claim 1, wherein the port two is polarization-maintaining port or non-polarization-maintaining port, and port three is polarization-maintaining port or non-polarization-maintaining port, the polarization-maintaining optical circulator further comprises a third birefringent crystal successively arranged between the dual-core waveguide and first birefringent crystal, the third birefringent crystal is parallel plate structures, the light input from port one forms a third crystal forward displacement in the third birefringent crystal, and the light input from port two forms a third crystal backward displacement in the third birefringent crystal;
the angle θ3 between the normal to the incidence surface of the light input from port one and the optical axis of the third birefringent crystal is the third walk-off angle, with −90°<θ3<0° or 0°<θ3<90°; the third walk-off angle being configured to control the third crystal forward displacement and the third crystal backward displacement;
an xyz coordinate system is established with the first direction as the positive direction of z-axis; the e-light oscillation plane through the optical axis of the first birefringent crystal intersects with the xy plane at the first line, and the angle between the first line and the y-axis is φ1; the e-light oscillation plane through the optical axis of the third birefringent crystal intersects with the xy plane at the third line, and the angle between the third line and the y-axis is φ3; wherein, |φ3−φ1|=90° or 270°, for coupling arbitrary polarization state of light input from port two into port three.

8. The polarization-maintaining optical circulator according to claim 1, wherein the port two is polarization-maintaining port or non-polarization-maintaining port, and port three is polarization-maintaining port or non-polarization-maintaining port, the polarization-maintaining optical circulator further comprises a second Faraday rotator and a third birefringent crystal successively arranged between the second birefringent crystal and the lens along the first direction, the second Faraday rotator and the third birefringent crystal are both parallel plate structures; the second Faraday rotator being configured to rotate the polarization direction of the light input from port one by an angle of α in the second rotation direction and then output it to the third birefringent crystal, and rotate the polarization direction of the light input from port two by an angle of α in the second rotation direction and then output it to the second birefringent crystal; the light input from port one forms a third crystal forward displacement in the third birefringent crystal, and the light input from port two forms a third crystal backward displacement in the third birefringent crystal;
the angle θ3 between the normal to the incidence surface of the light input from port one and the optical axis of the third birefringent crystal is the third walk-off angle, with −90°<θ3<0° or 0°<θ3<90°; the third walk-off angle being configured to control the third crystal forward displacement and the third crystal backward displacement;
an xyz coordinate system is established with the first direction as the positive direction of z-axis; the e-light oscillation plane through the optical axis of the second birefringent crystal intersects with the xy plane at the second line, and the angle between the second line and the y-axis is φ2; the e-light oscillation plane through the optical axis of the third birefringent crystal intersects with the xy plane at the third line, and the angle between the third line and the y-axis is φ3; wherein, |+3−φ2|=α, 90°+α, 180°+α or 270°+α, for coupling arbitrary polarization state of light input from port two into port three and realizing the dual-stage isolation function from port two to port one and from port three to port two.

9. The polarization-maintaining optical circulator according to claim 1, wherein the first birefringent crystal, and/or the second birefringent crystal, and/or the third birefringent crystal are combined crystals, the combined crystal is configured to form the same relative displacement and to compensate for the optical path difference.

10. The polarization-maintaining optical circulator according to claim 1, wherein the port two is a single-core waveguide and is configured to output the convergent beam or input the divergent beam; the lens is configured to focus the light input from port one into a convergent beam and couple it into the single-core waveguide, the single-core waveguide is configured to output the convergent beam; the single-core waveguide is further configured to input divergent linearly polarized light and output this divergent beam to the lens, the lens is further configured to converge the light input from the single-core waveguide into a convergent beam; or,
the port two is configured to output or input collimating beam; the lens is configured to collimate the light input from port one into collimating beam and output it to the port two, the port two is configured to output this collimating beam; the port two is further configured to input collimating beam and output this collimating beam to the lens, the lens is further configured to converge the light input from the port two into convergent beam.

11. The polarization-maintaining optical circulator according to claim 10, wherein the polarization-maintaining optical circulator further comprises a filter placed at the focal point of the lens between the lens and the port two when the port two is configured for outputting or inputting collimating beam; the filter is configured to reflect all or part of the collimating beam output from port one to port two.

12. The polarization-maintaining optical circulator according to claim 1, the polarization-maintaining optical circulator transmits the light input from port one to port two in the first direction, and the light input from port two to port three in the second direction, and the light input from port three to port four in the first direction, and the light input from port four to port one in the second direction, the first direction and second direction being opposite to each other;
the polarization-maintaining optical circulator comprising: a first dual-core waveguide configured to provide port one and port three, a first birefringent crystal, a first Faraday rotator, a lens, a second birefringent crystal and a second dual-core waveguide configured to provide port two and port four that are successively arranged along the first direction; the first birefringent crystal, the first Faraday rotator, and the second birefringent crystal are all parallel plate structures; wherein,
the port one is configured to input divergent linearly polarized light and the light input from port one enters the first birefringent crystal as o-light or e-light; the first birefringent crystal is configured to form a first crystal forward displacement of the light input from port one, and then output it to the first Faraday rotator; the first Faraday rotator is configured to rotate the polarization direction of the light input from port one by an angle of α in the first rotation direction and then output it to the lens, where α=45°; the lens is configured to converge the light input from port one into convergent beam and then output it to the second birefringent crystal; the second birefringent crystal is configured to form a second crystal forward displacement of the light input from port one, and then output it to the port two; the port two is configured to output the light input from port one to realize the transmission from port one to port two;
the port two is further configured to input divergent linearly polarized light with a fixed polarization direction which is the same o-light or e-light in the second birefringent crystal as the polarization direction of the light input from port one, and then output it to the second birefringent crystal; the second birefringent crystal is further configured to form a second crystal backward displacement of the light input from port two, and then output it to the lens; the lens is further configured to optically converge the light input from port two and output it to first Faraday rotator; the first Faraday rotator is further configured to rotate the polarization direction of the light input from port two by an angle of α in the first rotation direction and then output it to the first birefringent crystal; the first birefringent crystal is further configured to form a first crystal backward displacement of the light input from port two, and then output it to the port three, wherein, the polarization state of the light input from port two undergoes a 90° rotation in the first birefringent crystal relative to the light input from port one, causing the light input from port two to deviate from the light input from port one due to the transformation of the o-light and e-light in the first birefringent crystal, the walk-off between the light input from port one and the light input from port two is equal to the separation of two cores of the first dual-core polarization-maintaining waveguide, allowing the light input from port two to couple into port three; the port three is configured to output the light input from port two to realize the transmission from port two to port three;
the port three is configured to input divergent linearly polarized light with a fixed polarization direction which is the same o-light or e-light in the first birefringent crystal as the polarization direction of light input from port two, and then output it to the first birefringent crystal; the first birefringent crystal is configured to form a first crystal forward displacement of the light input from port three, and then output it to the first Faraday rotator; the first Faraday rotator is configured to rotate the polarization direction of the light input from port three by an angle of α in the first rotation direction and then output it to the lens, where α=45°; the lens is configured to converge the light input from port three into convergent beam and then output it to the second birefringent crystal; the second birefringent crystal is configured to form a second crystal forward displacement of the light input from port three, and then output it to the port four, wherein, the polarization state of the light input from port three undergoes a 90° rotation in the second birefringent crystal relative to the light input from port two, causing the light input from port three to deviate from the light input from port two due to the transformation of the o-light and e-light in the second birefringent crystal, the walk-off between the light input from port two and the light input from port three is equal to the separation of two cores of the second dual-core polarization-maintaining waveguide, allowing the light input from port three to couple into port four; the port four is configured to output the light input from port three to realize the transmission from port three to port four;
the port four is further configured to input divergent linearly polarized light with a fixed polarization direction which is the same o-light or e-light in the second birefringent crystal as the polarization direction of light input from port three, and then output it to the second birefringent crystal; the second birefringent crystal is further configured to form a second crystal backward displacement of the light input from port four, and then output it to the lens; the lens is further configured to optically converge the light input from port four and output it to first Faraday rotator; the first Faraday rotator is further configured to rotate the polarization direction of the light input from port four by an angle of α in the first rotation direction and then output it to the first birefringent crystal; the first birefringent crystal is further configured to form a first crystal backward displacement of the light input from port four, and then output it to the port one, wherein, the polarization direction of the light input from port four undergoes a 90° rotation in the first birefringent crystal relative to the light input from port three, causing the polarization direction of the light input from port four to be the same as the polarization direction of the light input from port one, and then enter the port one along the backward direction of the light input from port one to realize the transmission from port four to port one.

13. The polarization-maintaining optical circulator according to claim 12, wherein the first birefringent crystal, and/or the second birefringent crystal, and/or the third birefringent crystal are combined crystals, the combined crystal is configured to form the same relative displacement and to compensate for the optical path difference.
